(19) United States
(12) Patent Application Publication
(10) Pub. No.: US 2004/0259021 A1
(43) Pub. Date: Dec. 23, 2004

(54) Image transfer element, laser assemblage and process for thermal imaging

(76) Inventors: Easley Wallace JR., Newark, DE (US); Gregory C. Weed, Towanda, PA (US)

Correspondence Address: E.I. Du Pont De Nemours and Company, Legal Patents, 4417 Lancaster Pike, Wilmington, DE, 19805, US

(21) Appl. No.: 10/500,263

(22) PCT Filed: Feb. 4, 2003
(86) PCT No.: PCT/US03/03432

Related U.S. Application Data
(60) Provisional application No. 60/354,633, filed on Feb. 6, 2002.

(51) Int. Cl. G03C 8/00

(52) U.S. Cl. 430/200

(57) ABSTRACT

The present invention relates to an image transfer element for thermally induced image transfer, a laser assemblage and a process for producing a thermal image. More particularly, the present invention relates to an image transfer element comprising a colorant layer that contains a metal salt, a laser assemblage containing the image transfer element and process for producing a thermal image utilizing the image transfer element.

### CROSS REFERENCE TO RELATED APPLICATION

This nonprovisional application is related to U.S. Ser. No. 60/354,633 which is incorporated herein by reference in its entirety.

### FIELD OF THE INVENTION

The present invention relates to an image transfer element, a laser assemblage and a process for producing a thermal image. More particularly, the present invention relates to an image transfer element comprising a colorant layer that contains a metal salt.

### BACKGROUND OF THE INVENTION

Generally, laser-induced thermal transfer processes are well known in the art for applications such as color proofing and lithography, wherein the processes include transfer steps such as dye sublimation, dye transfer, melt transfer and ablative material transfer.

Typical laser-induced processes in the art utilize a laserable assemblage comprising an image transfer element, which includes a colorant layer disposed upon a donor element, wherein the areas of the donor element exposed to a laser are transferred to a receiver element. This imagewise exposure occurs in select regions of the laserable assemblage, such that the transfer of colorant material from the image transfer element to the receiver element comes about one pixel at a time. The process may be controlled using computers, which provide a high level of resolution and speed.

The quality of the colorant, and therefore the image, transferred to the receiver element and the efficiency with which the process is performed, is dependent upon various laser conditions including relative humidity, laser power (measured in watts) and drum speed. In general, typical images produced, where the relative humidity is below normal, require highly controlled exposure conditions, such as, drum speed (in rpm), exposure power in watts, and relative humidity.

U.S. Pat. Nos. 5,523,192 and 6,146,792 and European Patent Application No. 1 092 554 A2 (all to Blanchet-Fincher et al. known collectively as the “Blanchet-Fincher patents”) disclose transfer elements for use in laserable assemblages in which the transfer layer can contain, as a thermal amplification additive, those additives which decomposes to form nitrogen, such as, diazo alkyls, diazonium salts and azido (—N₃) compounds; ammonium salts; oxides which decompose to form oxygen; carbonates; and peroxides. Furthermore a surfactant is described as a possible additive for use in the transfer layer, but in amounts which are minimized in order to avoid a deleterious affect in the final product, as illustrated in the examples where the amounts are relatively low. The '792 patent, in Examples 4-5 and 6-7 also teaches the use of ammonium hydroxide or potassium hydroxide to neutralize the dispersant of the transfer layer. The Blanchet-Fincher patents do not describe the metal salts of the instant invention. Moreover, the Blanchet-Fincher patents do not disclose the use of a surfactant additive, specifically (Zonyl FSA®), normally employed in minor amounts as a surfactant, in a greater than surfactant amount, in order to obtain a transfer element with modified imaging latitude. The Blanchet-Fincher patents teach away from the use of excess amounts of a surfactant to avoid a detrimental effect on the final product.

There is a need within the industry for a robust image transfer element and a robust image transfer process that are both capable of providing high quality images over a variety of laser operating conditions. Thus, the object of the present invention is to provide improved imaging latitude, enhanced color stability over time, an image with a high optical density over a broad range of laser operating conditions, high quality images over a broad range of laser operating conditions such as drum speed and laser power, as well as address the problem of imaging sensitivity to low humidity. Still further, once the image that was transferred to a receiving element has been laminated to a receptor, there is a need for image density stability and color stability over time, typically a period of at least 30 days for color proofs. Current image transfer films experience a delta E of 7 or greater over a period of 30 days, however, a delta E of 2 or less over a period of 30 days is preferable.

### SUMMARY OF THE INVENTION

The present invention provides improved imaging latitude and high quality images over a broad range of laser operating conditions. The present invention relates to an image transfer donor element comprising:

(a) a donor element support;

(b) a colorant layer disposed upon said donor element support;

(c) at least one metal salt dispersed within the colorant layer; and preferably

(d) an optional at least one heating layer disposed between the donor element support and the colorant layer.

The present invention also relates to a process for producing a thermal image, wherein the process comprises the steps of:

(a) imagewise exposing the laser assemblage to a laser;

(b) separating a donor element from a receiver element; and

optionally

(c1) transferring the image receiving layer to a permanent substrate; or

(c2) transferring the image receiving layer to an intermediate element and subsequently to a permanent substrate; or

(c3) removing the receiver support resulting in an assemblage or sandwich comprising the permanent substrate, the thermoplastic layer, the colored transfer image, and the image receiving layer.

### DETAILED DESCRIPTION OF THE INVENTION

The present invention relates to image transfer donor elements used in thermal imaging processes. The present invention has been found to provide improved imaging latitude, and particularly, it addresses the problem of low humidity sensitivity. Moreover, the image transfer element of this invention has been found to provide high quality images over a broad range of laser operating conditions including, but not limited to, laser power (in Watts) and drum speed. The invention has been found to decrease microdropouts, imaging defects that lead to regions of poor optical density. The image transfer element of this invention also provides images demonstrating color stability over time.

The present invention relates to an image transfer donor element comprising:

(a) a donor element support;

(b) a colorant layer disposed upon said donor element support; and

(c) at least one metal salt dispersed within the colorant layer; and preferably

(e) an optional at least one heating layer disposed between the donor element support and the colorant layer.

The term “image latitude” as used herein, shall refer to the range of optical densities of an image formed on a substrate by laser imaging over a broad operating range of the laser imager, wherein the optical density ranges from about 0.8 to about 3.0 over a laser energy transfer ranging from 300 mJ/cm² to about 700 mJ/cm². The optical density depends on the particular color being analyzed, wherein the preferred optical densities are 1.41 for cyan; 1.51 for magenta; 0.96 for yellow; and 1.85 for black.

The image transfer donor element of the present invention comprises a support and a colorant layer disposed upon said donor element support. In addition to the colorant layer, the donor element support may also include one or more additional layers such as at least one ejection layer, at least one heating layer or a combination thereof, as described in U.S. Pat. No. 6,146,792 (Blanchet-Fincher et al.), which is incorporated herein by reference in its entirety. Additionally, the donor element support may contain fillers such as, for example, silica, which provide a roughened surface on the back side of the donor element. The roughened surface imparts slip properties and is important for film handling.

The donor element support of the present invention may be any conventional film known within the art, however a polyester film comprising a co-extruded polyethylene terephthalate or a polyolefin film comprising polypropylene, polyethylene, or paper, polyethylene naphthanate, polycarboates, fluoropolymers, polyacetals is preferred. The donor element support typically has a thickness greater than about 25 microns and preferably in the range of about 100 microns. The donor element support may be plasma treated in order to improve adhesion to any subsequently deposited layers.

The colorant layer of the present invention comprises at least one layer of a polymeric binder, and a metal salt, a surfactant, and a colorant all dispersed within the binder. The addition of a NIR dye is optional. The colorant layer generally has a thickness in the range of about 0.1 to about 5.0 micrometers, and preferably in the range of about 0.1 to about 1.5 micrometers. A thickness greater than about 5 micrometers is generally not useful as it requires excessive energy in order to be effectively transferred to the receiver.

While it is typical to have a single colorant layer, it is also possible to have more than one colorant layer, where the various colorant layers may comprise the same or different compositions, so long as they all function as described herein. The total thickness of the multiple colorant layers is within the ranges given above.

The binder of the present invention is preferably a polymer, however, any film-forming material capable of holding the colorant, surfactant, metal salts and other components and additives and which is capable of thermally induced image transfer may be used. The binder may be the same or different than the polymer utilized for the ejection layer. Specifically, the binders include, but are not limited to, polymers having a decomposition temperature greater than about 300° C. and preferably greater than about 350° C.; binders having a melting point of less than about 250° C.; binders plasticized to the extent that the glass transition temperature is less than about 70° C.; heat-fusible binders, such as, for example, waxes, wherein the wax may be either the sole binder or cobinder utilized to decrease the melting point of the colorant layer; those binders that do not self-oxidize, decompose or degrade at the temperatures achieved during exposure to the laser, wherein the exposed areas of the image transfer element (i.e., at least the colorant and the binder) are transferred intact to the receiver element; and those binders formed from the polymerization of acrylic monomers such as, for example, acrylic acid and methacrylic acid and the alkyl esters thereof resulting in polymers such as, for example, poly(methyl methacrylate), polyethylmethacrylate, polybutylmethacrylate, polyethylacrylate, polybutylacrylate and the like.

Still further, the binders may be polymers or copolymers of monomers (A), (B) and/or (C), wherein copolymers of two or more of monomers (A), (B) and (C) incude a copolymer of monomers (A) and (B), a copolymer of monomers (B) and (C), a copolymer of monomers (A) and (C) or a copolymer of monomers (A), (B) and (C). Monomer (A) includes, but is not limited to, carboxyl group-containing monomers, such as, acrylic acid, methacrylic acid, maleic acid, fumaric acid, crotonic acid, taconic acid, citraconic acid, mesaconic acid and cinnamic acid; hydroxyl group-containing monomers, such as, 2-hydroxyethyl(meth)acrylate, 2-hydroxypropyl(meth)acrylate and 3-hydroxypropyl(meth)acrylate; phenolic hydroxyl-group containing monomers, such as, o-hydroxystyrene, m-hydroxystyrene and p-hydroxystyrene; and other alkali-soluble monomers. Monomer (B) includes, but is not limited to, (meth)acrylic acid esters containing no hydroxyl group, such as, methyl(meth)acrylate, ethyl (meth)acrylate, n-propyl(meth)acrylate, i-propyl(meth)acrylate, n-butyl(meth)acrylate, i-butyl(meth)acrylate, sec-butyl(meth)acrylate, t-butyl(meth)acrylate, benzyl(meth)acrylate and glycidyl(meth)acrylate; aromaticvinyl monomers, such as, styrene and a-methyl styrene; conjugated dienes, such as, 1,3-butadiene and isoprene; and the like. Monomer (C) includes, but is not limited to, polystyrene, polymethyl(meth)acrylate, polyethyl(meth)acrylate and polybenzyl(meth)acrylate. The identity and number or fraction of monomer units in the polymer or copolymer can vary significantly.

Examples of suitable binders include, but are not limited to, a homopolymer or copolymer of acrylic acid, a homopolymer or copolymer of esters of acrylic acid, a homopolymer or copolymer of methacrylic acid, a homopolymer or copolymer of esters of methacrylic acid, a homopolymer or copolymer of alkyl methacrylic acid, a homopolymer or copolymer of esters of alkyl methacrylic acid acrylate esters (i.e., styrene/meth-methacrylate); copolymers of styrene and olefin monomers (i.e., styrene/ethylene/butylene); copolymers of styrene and acrylonitrile; fluoropolymers; copolymers of (meth)acrylate esters with ethylene and carbon monoxide; (meth)acrylate block copolymers, and (meth)acrylate copolymers containing other comonomer types, such as styrene or maleic anhydride; polycarbonates; (meth)acrylate homopolymers and copolymers; polysulfones; polyurethanes; polyesters; and combinations thereof. The monomers utilized for the above-noted polymers can either be substituted or unsubstitited. Further examples of suitable binders that may be useful in the present invention are disclosed in U.S. Pat. No. 5,773,188, U.S. Pat. No. 5,622,795, U.S. Pat. No. 5,593,808, U.S. Pat. No. 5,156,938, U.S. Pat. No. 5,256,506, U.S. Pat. No. 5,171,650 and U.S. Pat. No. 5,681,681 which are hereby incorporated by reference herein in their entireties. Examples of preferred binders include starch derivatives, carboxymethylcellulose or polyvinyl alcohols and aqueous dispersions (lattices) based upon acrylic acid, acrylic acid esters, acrylonitrile, vinyl acetate, butadiene or styrene, and combinations thereof.

Still further, the binder may contain minor amounts of acid, such as, latent acid from a polymerization initiator, for example, ammonium persulfate. For example, a particular polymer is a methylmethacrylate/butylmethacrylate copolymer synthesized with ammonium persulfate polymerization initiator. Each polymer chain thus contains a sulfonic acid end group which is neutralized with a volatile base such as 2-amino-2-methyl-1-propanol.

The metal salts of the present invention are dispersed within the binder of the colorant layer, wherein the metal salts have the following structure:

Mₐ⁺ⁿX_{b}^{-q}

wherein, M⁺ⁿ is an organic cation, an inorganic cation and mixtures thereof selected from the group consisting of NH₄⁺, N(R¹)₄⁺, or S(R¹)₃, wherein R¹ is an aliphatic group containing 1 to 6 carbon atoms and, optionally one or more heteroatoms, or a metal atom selected from groups Ia, IIa, IIIa, VIII, Ib, IIb of the Periodic Table of the Elements; n is selected from the group consisting of 1, 2 or 3; X is an anionic species wherein it is selected from the group consisting of an anion or an aliphatic group containing from 1 to 5 carbon atoms containing an anion; q is selected from the group consisting of 1, 2 or 3; and a and b integers wherein (a)×(n)=(b)×(q). Preferably, however, M⁺ⁿ is selected from the group consisting of quaternary amines, such as, N(CH₃)₄⁺, N(C₂H₅)₄⁺, N(C₃H₇)₄⁺, N(C₄H₉)₄⁺; sulfonium cations, such as, S(CH₃)₃⁺, S(C₂H₅)₃⁺, S(C₃H₇)₃⁺, S(C₄H₉)₃⁺; or inorganic cations, such as, Na⁺¹, Li⁺¹, K⁺¹, Mg⁺², Ca⁺², Sr⁺², Ba⁺², Fe⁺², Fe⁺³, Cu⁺², Zn⁺², and Al⁺³; and X⁻ is selected from the group consisting of halogen elements or oxides of phosphorous, sulfur, or carbon, such as, for example phosphates, sulfates, or carbonates. Further, specific examples include, but are not limited to, SO₄⁻², SO₃⁻², HSO₃⁻, S₂O₃⁻, S₂O₅², OAc⁻ (acetate), PO₄⁻³, HPO₄⁻², H₂PO₄⁻, F⁻, Cl⁻, Br⁻, I⁻, CO₃², HCO₃⁻, and Acac⁻² (Acetylacetonate).

Generally, the metal salt of the present invention is selected from the group consisting of magnesium sulfate, magnesium acetate, calcium acetate, zinc acetate, magnesium chloride, aluminum sulfate, calcium chloride and combinations of mono- and cations, such as, AlK(SO₄)₂ and Al(NH₄)(SO₄)₂ Preferably, the metal salts are anhydrates or hydrates of metal salts such as, for example, Mg(OAc)₂ and CaCl₂. Combinations of these metal salts may also be used in the present invention; for example, Tamol 960 (polymethacrylic acid sodium salt) may be used in conjunction with sodium acetate, magnesium acetate, magnesium sulfate and the like.

The metal salts of the present invention are typically employed in an amount ranging from about 1 to about 10% by weight, preferably about 3 to about 5% by weight, based on the total weight solids content of the colorant layer.

A particular embodiment of the present invention utilizes a carboxylate salt as the metal salt. Typically the carboxylate salt may be aliphatic or aromatic and comprises a carbon chain length of 1 to 25 carbon atoms with, optionally, one or more heteroatoms. Examples of suitable heteroatoms include, but are not limited to, nitrogen, oxygen, sulfur, and a halogen such as chlorine, bromine or iodine. The carboxylate salt further comprises at least one mono-, di- or trivalent cation. The choice of cation is not particularly important, however, it can be selected to allow water solubility or dispersibility, and wherein the carboxylate salts may typically be monofunctional or multifunctional. Examples of suitable multifunctional carboxylates include, but are not limited to, citrate, tartarate, succinates and the like. Examples of suitable monofunctional carboxylates include, but are not limited to, acetate, propionate, butyrates, pentaoates, hexanoates and the like.

Examples of suitable carboxylate anions, which have also been found to impart relative humidity latitude include, but are not limited to, formate; alkyl acrboxylates, such as, acetate, citrate, ascorbate, tartrate; aromatic carboxylates, such as, benzoate, substituted benzoates, glutarate, glutamate, valarate, adipate, stearate, homopolymers and copolymers of acrylic, methacrylic, itaconic, maleic, fumaric and styrene sulfonic acids, and 3-(2-(perfluoroalkyl)ethylthio)propionate (F(CF₂CF₂)₃₋₈CH₂CH₂SCH₂CH₂CO₂⁻).

Examples of suitable carboxylate cations for the salt include, but are not limited to, ammonium, lithium, sodium, potassium, rubidium, magnesium, calcium, zinc, copper, silver, aluminum, and tetramethylammonium, wherein the cations are mono-, di-, tri-, multivalent or mixtures thereof.

Carboxylate salts useful as surfactants are characterized by a hydrophilic tail constructed primarily of a long chain of carbon atoms (typically greater than 12 carbon atoms with optional heteroatoms) which form micelles in aqueous solutions and a polar hydrophobic end. An example of a carboxylate salt used as a surfactant is sodium dodecylsulfate.

The effective amount for a typical surfactant is considered insufficient to achieve the results of the present invention. Surfactant effective amounts are usually less than about 1 weight percent based on the total weight of the colorant layer, based on solids. Typically, the surfactant, such as, for example, Zonyl FSA®, is utilized in an amount ranging from about 0.1 to about 6.0% based on the total solids content.

The existence of a metal salt in a film may be determined in several ways, including, atomic absorption analysis and combustion elemental analysis.

Several methods may be employed to make the salt-containing colorant layer. A first method is the addition of a salt, such as the metal salts herein described, to the colorant layer composition followed by drying the colorant layer composition subsequent to its application onto the support. A second method of making the salt-containing colorant layer contemplated by the present invention is the addition of a nonvolatile base to an acid-containing colorant layer composition resulting from an acidic binder, such as, a polymer or copolymer of acrylic acid or methacrylic acid. Adding such a nonvolatile base to an acidic polymer binder provides a fully neutralized or partially neutralized polymer binder. The method also provides an image transfer element that produces final images having improved color stability.

Alternatively, the nonvolatile base and the acidic polymer binder can be added to a colorant layer composition, such that the salt forms by their addition to the colorant layer composition and remains, after the colorant layer is applied to the support and dried, to form the colorant layer of the image transfer element.

Examples of suitable acidic polymers include, but are not limited to, copolymers of styrene with acid containing monomers such as acrylic acid, methacrylic acid, itaconic acid, or maleic acid; polyacrylic acid; polymethacrylic acid; and copolymers of alkylmethacrylates, alkylacrylates, and acid containing monomers well known to those skilled in the art. Typically the alkyl groups contain from 1 to 20 carbon atoms.

Examples of suitable nonvolatile bases include, but are not limited to, tertiary amines such as tributyl amine, 2-amino-2-methylpropanol, N,N-dimethyl 2,6-diisopropylaniline, N,N-dimethylethanolamine and diisopropylaniline, or inorganic bases such as, Na₂HPO₄, Na₃PO₄, and Na₂SO₃, and quaternary ammonium hydroxides. In one embodiment, the invention comprises a nonvolatile base in combination with the metal salt.

The colorant layer may further contain additional materials, known in the art for use in colorant layers used in image transfer elements, especially those that enhance the function of the colorant layer and do not interfere with the colorant transfer process. Examples of suitable additives include, but are not limited to, coating aids, plasticizers, flow additives, slip agents, anti-halation agents, anti-static agents, stabilizers, surfactants, as well as any other conventional additive known to be used in the formulation of coatings. Those skilled in the art would recognize that care should be taken to avoid additives, or excessive amounts of otherwise desirable additives, that may impart unwanted color, especially in color proofing applications, or additives that may decrease durability and print life in lithographic printing applications.

The colorant layer may be coated on the support using a solution, however, it is typical to coat the layer(s) using a dispersion. Any suitable solvent can be used as a coating solvent, as long as it does not deleteriously affect the properties of the assemblage, using conventional coating techniques or printing techniques, for example, gravure printing. A typical solvent is water. The colorant layer may be applied by a coating process accomplished using, for example, WaterProof® Color Versatility Coater (sold by E.I. du Pont de Nemours and Company, Wilmington, Del.) and application of the colorant layer can thus be achieved shortly before the exposure step. This also allows for the mixing of various basic colors together to fabricate a wide variety of colors to match the Pantone® color guide currently used as one of the standards in the proofing industry.

The present invention, as previously noted, may also further comprise one or more additional layers, such as, for example, at least one ejection layer, at least one heating layer, and a combination thereof.

The optional at least one heating layer is preferably utilized in the present invention and functions to absorb the laser radiation and convert this radiation into heat, wherein the heating layer is typically deposited onto the ejection layer. When more than one heating layer is utilized, the layers may comprise the same or different compositions. The heating layer may comprise either organic or inorganic compounds, wherein the compounds may inherently absorb laser radiation or further include additional laser-radiation absorbing compounds. Typically, the thickness of the heating layer or layers in total, is in the range of about 20 Angstroms to about 0.1 micrometer, however, a thickness of about 40 Angstroms to about 100 Angstroms is preferred.

The heating layer(s) may be made according to those methods well known to those skilled in the art. The heating layer(s) can be applied using any of the well-known techniques for providing thin metal layers, such as sputtering, chemical vapor deposition, and electron beam.

Examples of laser-radiation absorbing compounds include metals (chromium, aluminum), carbon black, and NIR cyanine dyes. These compounds are typically used individually, however, they may also be used in combination with one another.

Examples of suitable inorganic materials include, but are not limited to, transition metal elements and metallic elements of Groups IIIA, IVA, VA, VIA, VIIIA, IIIB, IIIB, and VB of the Period Table of the Elements (Sargent-Welch Scientific Company (1979)), their alloys with each other, and their alloys with the elements of Groups IA and IIA. Examples of a suitable Group VIA metal and a Group IVB nonmetallic element are Tungsten (W) and Carbon, respectively. Preferably, the transition metals elements include Al, Cr, Sb, Ti, Bi, Zr, Ni, In, Zn, and their alloys and oxides. Preferably, the heating layer material comprises titanium dioxide.

While it is typical to have a single heating layer, it is also possible to have more than one heating layer, where the various heating layers may comprise the same or different compositions, so long as they all function as described herein. The total thickness of the multiple heating layers should be within the ranges given above.

The optional at least one ejection layer is typically flexible and capable of providing enough force to effect transfer of the colorant layer to the receiver element in the exposed areas. When heated, the ejection layer decomposes into gaseous molecules providing the necessary pressure to propel or eject the exposed areas of the colorant layer onto the receiver element. The ejection layer typically comprises a polymer having a relatively low decomposition temperature (typically less than about 350° C., preferably less than about 325° C., and more preferably less than about 280° C.). However, in the case of polymers having more than one decomposition temperature, the first decomposition temperature is usually lower than 350° C. Furthermore, in order for the ejection layer to have suitably high flexibility and conformability, it should have a tensile modulus that is less than or equal to about 2.5 Gigapascals (GPa), preferably less than about 1.5 GPa, and more preferably less than about 1 Gigapascal (GPa). Additionally, the polymer of the ejection layer should be dimensionally stable, wherein if the laserable assemblage is imaged through the ejection layer, the ejection layer should be capable of transmitting the laser radiation, and not be adversely affected by this radiation.

The ejection layer typically has a thickness of about 25 micrometers to about 200 micrometers. However, a preferred thickness is about 25-100 micrometers, and a most preferred thickness of about 50-75 micrometers.

Examples of suitable polymers for the at least one ejection layer include, but are not limited to, (a) polycarbonates having low decomposition temperatures (Td), such as, polypropylene carbonate; (b) substituted styrene polymers having low decomposition temperatures, such as, poly(alpha-methylstyrene); (c) polyacrylate and polymethacrylate esters, such as, polymethylmethacrylate and polybutylmethacrylate; (d) cellulosic materials having low decomposition temperatures (Td), such as, cellulose acetate butyrate and nitrocellulose; (e) polymers such as polyvinyl chloride, poly(chlorovinyl chloride) polyacetals, polyvinylidene chloride, polyurethanes with low Td, polyesters, polyorthoesters, acrylonitrile and substituted acrylonitrile polymers, maleic acid resins, and copolymers of polymers (a) through (e); and (f) mixtures of polymers (a) through (e). When more than one ejection layer is utilized, the layers may comprise the same or different compositions

U.S. Pat. No. 5,156,938, which is incorporated by reference herein in its entirety, provides examples of suitable polymers having low decomposition temperatures including polymers that undergo acid-catalyzed decomposition, wherein it is desirable to include one or more hydrogen donors with such polymers. Preferably, however, the at least one ejection layer comprises polymers such as, for example, polyacrylate and polymethacrylate esters, low Td polycarbonates, nitrocellulose, poly(vinyl chloride) (PVC), and chlorinated poly(vinyl chloride) (CPVC), and more preferably poly(vinyl chloride) and chlorinated poly(vinyl chloride).

The optional at least one ejection layer may further contain additives that are conventionally used in the formulation of coatings, with the proviso that such additives do not interfere with the essential function of the layer. Examples of preferred additives include coating aids, flow additives, slip agents, anti-halation agents, plasticizers, antistatic agents, surfactants, and combinations thereof as well as any others which are known to be used in the formulation of coatings.

While it is typical to have a single ejection layer, it is also possible to have more than one colorant layer, where the various ejection layers may comprise the same or different compositions, so long as they all function as described above. The total thickness of the multiple ejection layers should be within the ranges given above.

The at least one ejection layer may also be coated onto a temporary support such as a dispersion in a suitable solvent, provided that the resulting ejection layer(s) obtained upon drying are sufficiently transparent such that little or no scattering of the laser light occurs. In most cases, it is preferable to coat the ejection layer(s) from a solution to insure that a transparent layer(s) results. Any suitable solvent may be used as a coating solvent, as long as it does not have any deleterious effects on the laserable assemblage, using conventional techniques, such as those used in, for example, gravure printing. In those cases where a temporary support is utilized for coating the ejection layer, it is removed at some point in the manufacture of the image transfer donor element.

The image transfer donor element may also have additional layers such as, for example, an antihalation layer or an anchoring layer. The antihalation layer can be located on the side of the flexible ejection layer opposite the colorant layer. Materials that can be used as antihalation agents are well known in the art. The anchoring layer may also be used on either side of the flexible ejection layer and such a layer is also well known in the art.

In some embodiments of the present invention, a single top layer containing a material functioning as a heat absorber and a colorant can be employed, wherein the top layer has a dual function of being both a heating layer and a colorant layer. A typical material functioning as a heat absorber and colorant is carbon black, a broad band absorber absorbing at 830 NM. This top layer does not contain any added NIR dye.

The colorant of the present invention is an image-forming colorant such as a pigment, a dye, a color-forming dye and combinations thereof, which may comprise either substantially transparent or opaque pigments and may be either organic or inorganic. Examples of suitable inorganic pigments include, but are not limited to, for example, carbon black and graphite. Examples of suitable organic pigments include, but are not limited to, for example, metal phthalocyanines, e.g., copper phthalocyanine, quinacridones, epindolidiones, Rubine F6B (C.I. No. Pigment 184); Cromophthal® Yellow 3G (C.I. No. Pigment Yellow 93); Hostaperm® Yellow 3G (C.I. No. Pigment Yellow 154) (the aforementioned pigments are manufactured by the Clariant Corporation, Coventry R.I.); Monastral® Violet R(C.I. No. Pigment Violet 19); 2,9-dimethylquinacridone (C.I. No. Pigment Red 122); Indofast® Brilliant Scarlet R6300 (C.I. No. Pigment Red 123); Quindo Magenta RV 6803; Monastral® Blue G (C.I. No. Pigment Blue 15); Monastral® Blue BT 383D (C.I. No. Pigment Blue 15); Monastral® Blue G BT 284D (C.I. No. Pigment Blue 15); Monastral® Green GT 751D (C.I. No. Pigment Green 7) (the aforementioned pigments are manufactured by Ciba Specialty Chemicals Corporation, High Point N.C.), those disclosed by U.S. Pat. Nos. 5,171,650; 5,672,458; and 5,516,622, the disclosures of which are hereby incorporated by reference; equivalents of the above-noted pigments and combinations thereof.

For color filter array applications, high transparency pigments (wherein at least about 80% of visible light transmits through the pigment) are typically utilized such that the pigments are of a small particle size, preferably about 100 nanometers.

In accordance with principles well known to those skilled in the art, the concentration of pigments can be chosen according to the desired optical density of the final image. The amount of pigment will depend on the thickness of the active coating and the absorption of the colorant. Optical densities of the images are typically greater than 1.00 absorbance units, as measured through filter functions of a typical reflectance densitometer, such as, the X-Rite 938 Spectrodensitometer (manufactured by X-Rite Incorporated of Grandville, Mich.).

The pigments of the present invention are preferably used in combination with a dispersant in order to achieve the highest practical combination of color strength, transparency and gloss. The desired color strength is the highest optical density that can be obtained from a given amount of a specific pigment by proper handling, such as, use of dispersing aids and milling conditions. Properties such as transparency, gloss and tint strength are used to define dispersion quality and can be use in quality control, however, it is desirable to achieve maximum color strength from pigments.

Generally, the dispersant used in combination with the pigment is an organic polymeric compound used to separate the fine pigment particles and avoid flocculation and agglomeration of the particles. The dispersant can be selected according to the desired characteristics of the pigment surface and other components in the composition as known by those skilled in the art. The dispersants utilized in the present invention are commercially available and well known to those skilled in the art.

Numerous dyes may also be utilized with the present invention which are well known in the art, include, but are not limited to, Anthraquinone dyes, e.g., Sumikaron Violet RS® (product of Sumitomo Chemical Co., Ltd.), Dianix Fast Violet 3R-FS® (product of Mitsubishi Chemical Industries, Ltd.), and Kayalon Polyol Brilliant Blue N-BGM®, and KST Black 146® (products of Nippon Kayaku Co., Ltd.); azo dyes such as Kayalon Polyol Brilliant Blue BM®, Kayalon Polyol Dark Blue 2BM®, and KST Black KR® (products of Nippon Kayaku Co., Ltd.), Sumikaron Diazo Black 5G® (product of Sumitomo Chemical Co., Ltd.), and Miktazol Black 5GH® (product of Mitsui Toatsu Chemicals, Inc.); direct dyes such as Direct Dark Green B® (product of Mitsubishi Chemical Industries, Ltd.) and Direct Brown M® and Direct Fast Black DO (products of Nippon Kayaku Co. Ltd.); acid dyes such as Kayanol Milling Cyanine 5R® (product of Nippon Kayaku Co. Ltd.); basic dyes such as Sumiacryl Blue 6G® (product of Sumitomo Chemical Co., Ltd.), and Aizen Malachite Greene® (product of Hodogaya Chemical Co., Ltd.); or any of the dyes disclosed in U.S. Pat. Nos. 4,541,830; 4,698,651; 4,695, 287; 4,701,439; 4,757,046; 4,743,582; 4,769,360 and 4,753,922, the disclosures of which are hereby incorporated by reference. The dyes and pigments of the present invention may be employed singly or in combination.

The above discussion was directed to color proofing, however, the image transfer donor element and process of the invention apply equally to the transfer of other types of materials in different applications, for example, using an image transfer element to make color filters, typically used in making liquid crystal display devices and flat panel displays. In general, the scope of the invention is intended to include any application in which solid material is to be applied to a receptor in a pattern.

One application of the invention is in making a radiation filter, such as a monochrome filter or a color filter. Radiation filters can be used in displays such as flat panel displays, liquid crystal displays, displays illuminated by organic light-emitting diodes, and displays illuminated by plasma processes. Displays may display one (monochrome) or more colors (e.g. red, green, and blue) including white, black, and greys.

The objects patterned with a colorant layer of the present invention can be used in liquid crystal display devices such as a flat panel display. Liquid crystal display devices generally include two spaced, partially or fully transparent panels which define a cavity that is filled with a liquid crystal material. One partially transparent panel may comprise a monochrome or color radiation filter of the present invention, or a radiation filter can be associated and aligned with the two panels. For actively-driven liquid crystal display devices, a transparent electrode is formed on one of the transparent panels, which electrode may be patterned or not, while individually addressable transparent electrodes are formed on the other of the transparent panels. Alignment layers are provided over the transparent electrode layers on both panels and are treated to orient the liquid crystal molecules in order to introduce a twist, e.g., of 90 degrees, between the panels. Thus, in one type of display the plane of polarization of plane polarized light will be rotated in a 90 degree angle as it passes through the twisted liquid crystal composition from one surface of the cell to the other surface. Orientations such as twisted nematic and super-twisted nematic can be used. Application of an electric field between the selected electrodes of the cell causes the oriented twist of the liquid crystal composition to be temporarily disrupted in the portion of the cell between the selected electrodes, thereby changing the polarization change of light transmitted through the liquid crystal composition. By use of optical polarizers on each side of the cell, polarized light can be fully or partially passed through the cell or extinguished, depending on whether or not an electric field is applied.

Each of the individual electrodes has a surface area corresponding or correlating to the area of one monochrome or color element known as a pixel. If the device is to have color capability, each pixel must be aligned with a color area, e.g., red, green or blue, of a color filter. Depending upon the image to be displayed, one or more of the pixel electrodes is energized during display operation to allow full light, no light or partial light to be transmitted through the color filter area associated with that pixel. The image perceived by a user is a blending of colors formed by the transmission of light through adjacent and nearby color filter areas.

The polymeric alignment layer described above can be any of the materials commonly used in the liquid crystal art. Examples of such materials include polyimides, polyvinyl alcohol and methyl cellulose. The transparent conducting electrode described above is also conventional in the liquid crystal art. Examples of such materials include indium tin oxide, indium oxide, tin oxide and cadmium stannate.

A thermal amplification additive may optionally be present in one or more of the colorant layers, ejection layers, antihalation layers, heating layers or any other layer of the image transfer element.

The optional thermal amplification additive functions to amplify the effect of the laser energy ability to generate heat, and thus, further increase sensitivity to the laser. The thermal amplification additive may be (1) a decomposing compound which, when heated, decomposes to form a gaseous by-product(s); (2) an absorbing dye which absorbs the incident laser radiation; (3) a compound which undergoes a thermally induced unimolecular rearrangement which is exothermic or (4) combinations thereof.

Decomposing compounds of group (1) include those compounds which decompose to form nitrogen, such as diazo alkyls, diazonium salts, and azido (—N3) compounds; ammonium salts; oxides which decompose to form oxygen; carbonates or peroxides; and combinations thereof. A specific example of such compounds is 4-diazo-N,N′ diethyl-aniline fluoroborate (DAFB).

An absorbing dye of group (2) is typically one that absorbs incident radiation in the infrared region, preferably in the near infared region. For imaging applications, it is also typical that the dye have very low absorption in the visible region. When the absorbing dye is incorporated into the ejection layer or other layer of the present invention, its function is to absorb the incident radiation and convert this into heat, leading to more efficient heating. Absorbing dyes of group (2) also include the infrared absorbing materials disclosed in U.S. Pat. Nos. 4,778,128; 4,942,141; 4,948,778; 4,950,639; 5,019,549; 4,948,776; 4,948,777 and 4,952,552 which are hereby incorporated by reference in their entireties.

Examples of suitable near infrared (NIR) absorbing dyes, which can be used alone or in combination, include, but are not limited to, poly(substituted) phthalocyanine compounds and metal-containing phthalocyanine compounds; cyanine dyes; squarylium dyes; chalcogenopyryioacrylidene dyes; croconium dyes; metal thiolate dyes; bis(chalcogenopyrylo)polymethine dyes; oxyindolizine dyes; bis(aminoaryl)polymethine dyes; merocyanine dyes; and quinoid dyes.

The weight percentage of the thermal amplification additive is generally present in the range of about 0.95 to about 11.5%, based on the solids content or weight basis of the colorant layer. The percentage can range up to about 25% of the total weight percentage of the colorant layer. These percentages are non-limiting and one of ordinary skill in the art can vary them depending upon the particular composition of the layer.

The laserable assemblage, of which the present invention is a part, also comprises a receiver element, to which the exposed areas of the colorant layer are transferred. The receiver element is typically an intermediate element in the process of the invention because the laser imaging step is normally followed by one or more transfer steps by which the exposed areas of the image transfer coating are transferred to a permanent substrate.

Generally, the exposed areas of the colorant layer will not be removed from the image transfer element in the absence of a receiver element. That is, exposure of the image transfer element alone to laser radiation does not cause colorant to be removed or transferred. In one embodiment, the donor element actually touches the surface of the image receiving coating of the receiver element. Typically, the donor element is releasably attached to the receiver element, wherein the donor element can be removed and reattached to the receiver element repeatedly without transfer of colorant prior to laser imaging. The donor and receiver elements are designed not to adhere when placed in contact under vacuum. Adhesion between the donor and receiving element only occur in laser exposed areas. Additionally, the present invention allows for the image to be transferred directly to the receiver support.

The receiver element may be any conventional receiver element known to those skilled in the art. Suitable receiver supports may be transparent or opaque and typically include, for example, but are not limited to, conventionally known dimensionally stable sheet materials; polyethylene terephthalate, polyether sulfone, a polyimide, a poly(vinyl alcohol-co-acetal), polyethylene, or a cellulose ester, such as cellulose acetate. Examples of suitable opaque support materials include, for example, polyethylene terephthalate filled with a white pigment such as titanium dioxide, ivory paper, or synthetic paper such as Tyvek® spunbonded polyolefin. Paper supports are preferred for proofing applications, while a polyester support, such as poly(ethylene terephthalate) is preferred for a medical hardcopy application, and glass is preferred for a color filter array application. Roughened supports may also be used in the receiver element, as is well known in the art.

The image receiving element may comprise one or more layers, wherein the outermost layer is optionally micro-roughened. Examples of layers include those formed from a polycarbonate; a polyurethane; a polyester; polyvinyl chloride; styrene/acrylonitrile copolymer; poly(caprolactone); poly(vinylacetate), vinylacetate copolymers with ethylene and/or vinyl chloride; (meth)acrylate homopolymers (such as butyl-methacrylate) and copolymers; and mixtures thereof. Preferably, the outermost image receiving layer is a crystalline polymer or poly(vinylacetate) layer. The crystalline image receiving layer polymers, for example, polycaprolactone polymers, preferably have melting points in the range of about 50 to about 64° C., more preferably about 56 to about 64° C., and most preferably about 58 to about 62° C. Blends made from 5-40% CAPA 650® (Solvay Interox, Houston, Tex.) (melt range 58-60° C.) and Tone P-300® (Dow Chemical, Midland, Mich.) (melt range 58-62° C.), both polycaprolactones, are particularly useful as the outermost layer in this invention. Typically, 100% of CAPA 650® or Tone P-300® is used. However, thermoplastic polymers, such as polyvinyl acetate, are also a preferable outermost receiver layer which has a higher melting point (softening point ranges of about 100 to about 180° C.).

Further, receiver elements are disclosed in U.S. Pat. No. 5,534,387, which is incorporated by reference herein in its entirety, wherein an outermost layer optionally capable of being micro-roughened, for example, a polycaprolactone or poly(vinylacetate) layer, is present on the ethylene/vinyl acetate copolymer layer disclosed therein.

Generally, the thickness of the outermost layer can range from about 0.1 microns to about 300 microns. However, an ethylene/vinyl acetate copolymer layer thickness can range from about 10 to 200 microns and the polycaprolactone layer thickness from about 0.2 to 10 microns. Typically, the ethylene/vinyl acetate copolymer contains more ethylene than vinyl acetate.

Most preferably, the image receiving element comprises the WaterProof® Transfer Sheet (available from E.I. du Pont de Nemours and Company) having coated thereon a polycaprolactone or poly(vinylacetate) layer. This image receiving layer can be present in any amount effective for the intended purpose. In general, good results have been obtained at coating weights in the range of about 5 to about 150 mg/dm², preferably about 20 to about 60 mg/dm².

In addition to the at least one image receiving layer, the receiver element may, optionally, further include one or more other layers between the receiver support and the image receiving layer, for example, a release layer and/or a cushion layer. The receiver support alone or the combination of receiver support and release layer is referred to as a first temporary carrier. The release layer provides the desired adhesion balance to the receiver support so that the image-receiving layer adheres to the receiver support during exposure and separation from the donor element, but promotes the separation of the image receiving layer from the receiver support in subsequent steps. The release layer can have a thickness in the range of about 1 to about 50 microns. Examples of materials suitable for use as the release layer include polyamides, silicones, vinyl chloride polymers and copolymers, vinyl acetate polymers and copolymers and plasticized polyvinyl alcohols. The cushion layer, which is a deformable layer, may also be present in the receiver element, typically between the release layer and the receiver support. The cushion layer increases the contact between the receiver element and the donor element, when assembled. Additionally, the cushion layer aids in the optional micro-roughening process by providing a deformable base under pressure and optional heat. Furthermore, the cushion layer provides excellent lamination properties in the final image transfer to a paper or other substrate. Examples of suitable elastomers for use as the cushion layer include copolymers of styrene and olefin monomers; such as, styrene/ethylene/butylene/styrene, styrene/butylene/styrene block copolymers, ethylene-vinylacetate and other elastomers useful as binders in flexographic plate applications.

Alternatively, the receiving element may comprise a permanent substrate for receiving the exposed area of the acid-containing image transfer image. Any type of conventionally known sheet material may be used including, but not limited to, cloth, wood, glass, china, most polymeric films, synthetic papers, thin metal sheets or foils, or almost any material that will adhere to the thermoplastic polymer layer. However, a paper substrate of any stock, is preferred, wherein the paper is typically the same paper upon which the image will ultimately be printed.

As noted above, the receiver element may act as an intermediate element, wherein the laser imaging step may be followed by at least one transfer step such that the image to be transferred, will be relocated to a permanent support comprising the materials described above. This is most likely the case in color proofing applications in which the multicolor image is built up on the receiver element and then transferred to the permanent support.

The present invention also relates to a process for producing a thermal image, wherein the process comprises the steps of:

(a) imagewise exposing the laser assemblage to a laser;

(b) separating a donor element from a receiver element; and optionally

(c1) transferring the image receiving layer to a permanent substrate; or

(c2) transferring the image receiving layer to an intermediate element and subsequently to a permanent substrate; or

(c3) removing the receiver support resulting in an assemblage or sandwich comprising the permanent substrate, the thermoplastic layer, the colored transfer image, and the image receiving layer.

The image transfer elements of the present invention can be prepared as described herein as well as by those methods described in U.S. Pat. No. 5,534,387 (Bodager et al.), which is hereby incorporated by reference in its entirety.

The laserable assemblage is normally prepared following the removal of a coversheet(s), if present, by placing the image transfer element in contact with the receiver element such that the colorant layer actually touches the image receiving layer on the receiver element. Vacuum and/or pressure can be used to hold the two elements together. As one alternative, the donor and receiver elements can be held together by fusion of layers at the periphery. As another alternative, the donor and receiver elements can be taped together and taped to the imaging apparatus, or a pin/clamping system can be used. As yet another alternative, the donor element can be laminated to the receiver element to afford a laserable assemblage. The laserable assemblage can be conveniently mounted on a drum to facilitate laser imaging.

After forming the image transfer element of the invention and the laserable assemblage, the laserable assemblage is imagewise exposed to laser radiation. The exposure step is typically effected at laser fluence suitable for the colorant layer. For example, the laser fluence for a cyan film ranges from about 400 mJ/cm² to 700 mJ/cm².

Various types of lasers can be used to expose the laserable assemblage. The laser is typically one emitting in the infrared, near-infrared or visible region. However, diode lasers emitting in the region of about 750 to about 870 nm are preferred, which offer a substantial advantage in terms of their small size, low cost, stability, reliability, ruggedness and ease of modulation. Diode lasers emitting in the range of about 780 to about 850 nm are most typical. Such lasers are available from, for example, Spectra Diode Laboratories (San Jose, Calif.). The device used for applying an image to the image receiving layer is the Creo Spectrum Trendsetter, which utilizes lasers emitting near 830 nm.

The laserable assemblage is exposed imagewise so that the exposed areas of the colorant layer are transferred to the receiver element in a pattern. The pattern itself can be, for example, in the form of dots or line work generated by a computer, in a form obtained by scanning artwork to be copied, in the form of a digitized image taken from original artwork, or a combination of any of these forms, which can be electronically combined on a computer prior to laser exposure. The laser beam and the laserable assemblage are in constant motion with respect to each other, such that each minute area of the assemblage, i.e., “pixel” is individually addressed by the laser. This is generally accomplished by mounting the laserable assemblage on a rotatable drum. A flat bed recorder can also be used.

The exposure may take place through the optional at least one ejection layer and/or the optional at least one heating layer of the donor element provided they are substantially transparent to the laser radiation.

The next step in the process of the invention is separating the donor element from the receiver element. Usually this is done by simply peeling the two elements apart, which generally requires very little peel force, and is accomplished by simply separating the image transfer support from the receiver element. This can be done using any conventional separation technique and can be manual or automatic without operator intervention.

Separation results in a laser generated color image, also known as the colored transfer image, typically a halftone dot image, comprising the transferred exposed areas of the colorant layer, being revealed on the image receiving layer of the receiver element. Typically, the colored transfer image formed by the exposure and separation steps is a laser generated halftone dot color image formed on a crystalline polymer layer, the crystalline polymer layer being located on a first temporary carrier which may or may not have a layer present directly on it prior to application of the crystalline polymer layer.

The process of the present invention may further comprise additional steps, wherein the so revealed colored image transfer image on the image receiving layer may then be transferred directly to a permanent substrate or it may be transferred to an intermediate element such as an image rigidification element, and then to a permanent substrate. Typically, the image rigidification element comprises a support having a release surface and a thermoplastic polymer layer.

A WaterProof® Laminator (manufactured by E.I. du Pont de Nemours and Company) is preferably used to accomplish the lamination. However, other conventional means may be used to accomplish contact of the color image carrying receiver element with the thermoplastic polymer layer of the rigidification element. The support having a release surface may then be removed, typically by peeling off, to reveal the thermoplastic film. The color image on the receiver element may then be transferred to the permanent substrate by contacting the permanent substrate with, typically laminating it to, the revealed thermoplastic polymer layer of the sandwich. Again a WaterProof® Laminator, (manufactured by E.I. du Pont de Nemours and Company), is typically used to accomplish the lamination. However, other conventional means may be used to accomplish this contact.

Another embodiment includes the additional step of removing, typically by peeling off, the receiver support resulting in the assemblage or sandwich comprising the permanent substrate, the thermoplastic layer, the colored transfer image, and the image receiving layer.

Also contemplated by the present invention is the formation of multicolor images. In proofing applications, the receiver element can be an intermediate element onto which a multicolor image is built up. An image transfer element comprising a first colorant layer is exposed and separated as described above. Thereafter, a second donor element having a colorant layer which is different than that of the first donor element forms a laserable assemblage with the receiver element having the image of the first colorant layer and is imagewise exposed and separated as described above. The steps of (a) forming the laserable assemblage with an image transfer element having a different colorant layer than that used before and the previously imaged receiver element, (b) exposing, and (c) separating are sequentially repeated as often as necessary in order to build the multi-colored image on the receiver element.

### EXAMPLES

These non-limiting examples demonstrate the processes and products described herein wherein images of a wide variety of colors were obtained. All temperatures throughout the specification were in ° C. (degrees Centigrade) and all percentages were weight percentages, unless indicated otherwise. The optical density was measured using a densitometer (X-Rite 938 Densitometer, X-Rite, Inc., Bradonville, Mich.).

Delta E (or dE) is a calculated value that compares the color of an image with respect to a standard color. The CIELAB color system is used. ‘dE vs the Standard’ is defined as the SQRT((‘L’−Lstd)**2+(‘A’−Astd)**2+(‘B’−Bstd)**2). In the appropriate measurements, the Waterproof® Proofing colors were used as the standard for calculating delta E. The CIELAB color system is described in “Principles of Color Proofing”, by Michael H. Bruno (Gama Communications, Salem, N.H., 1986), which is incorporated by reference herein in its entirety.

Glossary:

SDA 4927 2-(2-(2-chloro-3-(2-(1,3-dihydro-1,1-dimethyl-3-(4-sulfobutyl)-2H-benz[e]indol-2-ylidene)ethylidene)-1-cyclohexene-1-yl)ethenyl)-1,1-dimethyl-3-(4-sulfobutyl)-1H-benz[e]indolium, inner salt, free acid. CAS No. [162411-28-1], (H. W. Sands Corp., Jupiter, Fla.)

Crysta-lyn 551110 2-(2-(2-chloro-3-(2-(1,3-dihydro-1,1-dimethyl-3-(4-sulfobutyl)-2H-benz[e]indol-2-ylidene)ethylidene)-1-cyclohexene-1-yl)ethenyl)-1,1-dimethyl-3-(4-sulfobutyl)-1H-benz[e]indolium, sodium salt. CAS No. Unknown (Crysta-lyn Chemical Co., Johnson City, N.Y.)

30S330 Green Shade Phthalo Blue Waterborne Dispersion 40% solids (24 pigment and 16% binder) (Penn Color, Inc., Doylestown, Pa.)

32S187D Red Shade PCN Blue ACROVERSE PASTE 40% solids 40% solids (24 pigment and 16% binder) (Penn Color, Inc., Doylestown, Pa.)

FSA Zonyl® FSA fluorosurfactant (DuPont, Wilmington, Del.)

Surfynol® DF110D Defoamer 32% active solids. (Air Products and Chemicals, Inc.)

Binder 1 Methylmethacrylate/n-butylmethacrylate (76/24) copolymer latex emulsion at 37.4% solids (DuPont, Wilmington, Del.).

Zinpol® 127 Styrene acrylic latex emulsion at 38% solids (B. F. Goodrich, Cleveland, Ohio)

PEG 6800 Polyethylene glycol 6800 [CAS No. 25322-68-3], 100%, Scientific Polymer Products, Inc. Ontario, N.Y.)

Ammonium Citrate ([CAS#3458-72-8], 98%, Aldrich Chemical, Milwaukee, Wis.)

Sodium L-Tartrate dihydrate (CAS No. [6106-24-70], 99+%, Aldrich Chemical, Milwaukee, Wis.)

Sodium Acetate (CAS No. [127-09-3], 99+%, Aldrich Chemical, Milwaukee, Wis.)

Acumer® 1110 Sodium Salt of Polyacrylic acid/NaHSO₃, 4,500 MW, 45% solids in water, pH=6.7 (Rohm and Haas Company, Philadelphia, Pa.)

Acumer® 1850 Sodium Salt of Polymethacrylic acid, 30,000 MW, 30% solids in water, pH=9-10.8 (Rohm and Haas Company, Philadelphia, Pa.)

Tamol® 731 Sodium Salt of Maleic Anhydride copolymer, 15,000 MW, 30% solids in water, pH=9.5-10.5 (Rohm and Haas Company, Philadelphia, Pa.)

Tamol® 960 Sodium Salt of Polymethacrylic acid, 5,000 MW, 40% solids in water, pH=8-9 (Rohm and Hass Company)

NaOH Sodium hydroxide (CAS No. [1310-73-2], supplied as pellets or 50% aqueous solution, Aldrich Chemical, Milwaukee, Wis.)

Magnesium Acetate Tetrahydrate (CAS No. [16674-78-5], Fisher Scientific, Atlantic, Ga.)

Poly-Step B-1 (*ammonium nonylphenol ethoxylate sulfate) commercially available from Stepan Company of Northfield, Ill.

Ammonium Lauryl Sulfate (CAS No. [2235-54-3], 99 Fluka Chemika, Milwaukee, Wis.)

Methyl Methacrylate (CAS No. [80-62-6], 99+%, Aldrich Chemical, Milwaukee, Wis.)

Butyl Methacrylate (CAS No. [97-88-1], 99+%, Aldrich Chemical, Milwaukee, Wis.)

Ammonium Persulfate (CAS No. [7727-54-0], 99.99+%, Aldrich Chemical, Milwaukee, Wis.)

Magnesium Sulfate, anhydrous CAS No. [7487-88-9], Fisher Scientific, Atlantic, Ga.)

Hycar® 26256 Acrylic latex emulsion at 49.5% solids (B. F. Goodrich, Cleveland, Ohio)

32R164D Acroverse Paste 40% solids (24% pigment and 16% binder) (Penn Color, Inc., Doylestown, Pa.).

32S168D Carbazole Violet Acroverse Paste 41% solids (24.6% pigment and 16.4% binder) (Penn Color, Inc., Doylestown, Pa.).

FSO-100 Zonyl® FSO-100 fluorosurfactant (DuPont, Wilmington, Del.) Carboset® GA2123 Carboxylated acrylic colloidal dispersion (Acid#=105, pH=8.8, % solids=22.5%, B. F. Goodrich, Cleveland, Ohio).

DMEA N,N-Dimethylethanolamine (Aldrich Chemical, Milwaukee, Wis.)

Generally, the product is a Skyline Resin comprising a waterborne latex copolymer of methyl methacrylate and butyl methacrylate, wherein the resin is prepared via emulsion polymerization with ammonium persulate in an amount ranging from about 0.3 to about 0.75% based on the total weight of the monomers. A mixture of both anionic and nonionic emulsifiers was used. The Skyline Resin should have a solids content in the range of about 3540%; a pH in the range of about 8-10; an average molecular weight in the range of about 130,000 to about 250,000; a number average molecular weight in the range of about 45,000 to about 70,000 and a particle size (nm) in the range of about 130 to about 160.

### Example 1

Example 1 shows that the incorporation of ammonium citrate into a cyan donor composition resulted in improved imaging latitude for S1 of the present invention. The latex binder identified as Zinpol® 127 is a styrene acrylic latex.

A sample donor element (S1) of the present invention and a First Control (C1) were each prepared from a formulation of the ingredients listed below in Table 1a, wherein the amount of each ingredient is provided as parts by weight.

Each donor element comprises a 4 mil (about 100 microns) polyester backing (Melinex®) 574, DuPont Teijin Films) sputtered with chromium at a transmittance of 60%. The image transfer coatings were hand coated on the chromium layer using a wire wound rod to a dried coating weight of approximately 12 mg/sq dm.

The films were imaged using the Creo 3244 Spectrum Trendsetter (manufactured by Creo, Vancouver, BC) and imaged at power settings of 14, 15, 16, 17 and 18 watts; 10 evenly spaced drumspeeds per power setting; and a focus setting of 60 SD (surface depth) units as a setting on the Trendsetter instrument. The imaging equipment produced a laser-generated matrix of cyan color images on a receiver element for both C1 and S1.

The color image formed was then transferred to an image rigidification element comprising Vitel® 2700B polyester on a silicone release Mylar® substrate, as described in U.S. Pat. No. 6,294,308 Taylor, et al. The receiver support was peeled off and the image was contacted with an LOE paper (XPEDX, Marlton, N.J.) substrate followed by peeling off the image rigidification element support to form an image on an LOE paper substrate sandwiched between the polycaprolactone layer and the Vitel® 2700B polyester containing layer.

After imaging, each imaged film on the LOE paper was analyzed to assess the optical density using an X-Rite® 938 Spectrodensitometer. Cyan optical density readings were taken of images produced at a set laser power and over an evenly spaced range of energies at that power. The evenly spaced energy ranges were produced by incrementally adjusting the drum speed of the Trendsetter. Table 1c shows the average density of N solid images that were produced at a given laser power using N evenly spaced energies.

TABLE 1a

| | C1 | C1 Neat | S1 | S1 Neat |
|---|---|---|---|---|
| Ingredients | % Solids | Ingredients | % Solids | Ingredients |
| Distilled Water | 0.00 | 77.16 | 0.00 | 77.46 |
| Zinpol ® 127 | 67.33 | 15.95 | 65.33 | 15.47 |
| 30S330 G/S PCN | 29.27 | 6.58 | 29.27 | 6.58 |
| Crysta Lyn 551110 | 2.01 | 0.18 | 2.01 | 0.18 |
| Zonyl ® FSO | 1.39 | 0.13 | 1.39 | 0.13 |
| Ammonium Citrate | 0.00 | 0.00 | 2.00 | 0.18 |
| Total | 100.00 | 100.00 | 100.00 | 100.00 |

The films were imaged using a Creo 3244 Spectrum Trendsetter, (manufactured by Creo, Vancouver, BC) and at power settings of 14, 15, 16, 17, and 18 watts; 11 evenly spaced drumspeeds per power setting; and a focus setting of 65 SD units. The imaging equipment produced a laser-generated matrix of cyan color images on a receiver element for both C1 and S1.

Table 1b shows the average density of N solid images that were produced at a given laser power using N evenly spaced energies.

TABLE 1b

| Power | Energy Range | | C1 | S1 |
|---|---|---|---|---|
| (Watts) | (mJ/sq cm) | N* | Average Density | Average Density |
| 14 | 329 to 563 | 11 | 1.32 | 1.42 |
| 15 | 352 to 604 | 11 | 1.38 | 1.45 |
| 16 | 376 to 644 | 11 | 1.36 | 1.45 |
| 17 | 399 to 684 | 11 | 1.33 | 1.40 |
| 18 | 422 to 724 | 11 | 1.22 | 1.25 |

*N is a positive integer defining the number of evenly spaced exposure energies in the given energy range at the given power setting.

The improved imaging latitude is illustrated in Table 1b by comparing the average densities of each sample for both the First Control, C1, and S1, the composition containing ammonium citrate. The difference in average density over the power range of 14-17 watts, was greater for C1 (0.06) than for S1 (0.05). This indicates that the present invention provides better and more consistent optical density over the specified range of laser power settings. Still further, S1 of the present invention had a greater average density when compared to the corresponding samples of C1 for each power setting (14-18 Watts).

### Example 2

Example 2 shows the improved imaging latitude by the incorporation of increased surfactant, Zonyl® FSA, into a cyan donor composition.

A sample donor element (S2) of the present invention and a Second Control (C2) were prepared from a formulation of the ingredients listed below in Table 2a, wherein the amount of each ingredient is provided as parts by weight. Each donor element was prepared as in Example 1.

TABLE 2a

| | C2 % | C2 Neat | S2 | S2 Neat |
|---|---|---|---|---|
| Ingredients | Solids | Ingredients | % Solids | Ingredients |
| Distilled Water | 0.00 | 69.67 | 0.00 | 70.27 |
| Binder 1 | 76.19 | 24.45 | 73.18 | 23.48 |
| 30S330 G/S PCN | 14.88 | 4.46 | 14.88 | 4.46 |
| Penn Color 32S187D | 1.94 | 0.58 | 1.94 | 0.58 |
| SDA 4927 | 1.50 | 0.18 | 1.50 | 0.18 |
| Zonyl ® FSA | 0.99 | 0.12 | 4.00 | 0.48 |
| PEG 6800 | 4.00 | 0.48 | 4.00 | 0.48 |
| Surfynol ® DF110D | 0.50 | 0.06 | 0.50 | 0.06 |
| Total | 100.00 | 100.00 | 100.00 | 100.00 |

The films were imaged using the Creo 3244 Spectrum Trendsetter (manufactured by Creo, Vancouver, BC) and at power settings of 14, 15, 16, 17, and 18 watts; 11 evenly spaced drumspeeds per power setting. The imaging equipment produced a laser-generated matrix of cyan color images on a receiver element for both C2 and S2.

Density readings were taken and tabulated as in Example 1. Table 2b shows the average density and the standard deviation of N solid images that were produced at a given laser power using N evenly spaced energies.

TABLE 2b

| | Energy | | C2 | | S2 | |
|---|---|---|---|---|---|---|
| Power | Range | | Average | C2 | Average | S2 |
| (Watts) | (mJ/sq cm) | N* | Density | Std Dev | Density | Std Dev |
| 14 | 343 to 607 | 11 | 0.96 | 0.65 | 1.54 | 0.05 |
| 15 | 367 to 650 | 11 | 0.97 | 0.65 | 1.54 | 0.03 |
| 16 | 392 to 693 | 11 | 1.21 | 0.51 | 1.57 | 0.01 |
| 17 | 416 to 734 | 11 | 1.43 | 0.22 | 1.59 | 0.03 |
| 18 | 441 to 780 | 11 | 1.40 | 0.13 | 1.54 | 0.04 |

*N is a positive integer defining the number of evenly spaced exposure energies in the given energy range at the given power setting.

The improved imaging latitude is illustrated by comparing the average densities of each sample, where the difference in average density over the power range was much greater for C2 (0.47) than for S2 (0.05), the composition of the present invention containing increased Zonyl® FSA. This indicates that the present invention provides better and more consistent optical density over the specified range of laser power settings (14-18 watts) than is provided by C2. Still further, S2 of the present invention had a greater average density when compared to the corresponding samples of C2 for each power setting (14-18 Watts).

Alternatively, assessing the standard deviation of the density for each C2 and S2 sample over a range of power and exposure energy can show the improved imaging latitude of S2. The standard deviation data of Table 2b show that at each power setting, S2 had a lower standard deviation than C2 as well as a lower standard deviation difference across the power settings (14-18 watts), where the difference for S2 is 0.04 whereas C2 has a value of 0.52. Therefore, S2 had improved imaging latitude when compared to the C2 sample.

### Example 3

Example 3 shows the improved imaging latitude resulting from the incorporation of the salt, magnesium acetate, into a cyan donor composition.

A sample donor element (S3) of the present invention and a Third Control (C3) were prepared from a formulation of the ingredients listed below in Table 3a, wherein the amount of each ingredient is provided as parts by weight.

Each donor element was prepared as in Example 1.

TABLE 3a

| | C3 % | C3 Neat | S3 | S3 Neat |
|---|---|---|---|---|
| Ingredients | Solids | Ingredients | % Solids | Ingredients |
| Distilled Water | 0.00 | 72.11 | 0.00 | 72.35 |
| Binder 1 | 76.69 | 22.55 | 75.55 | 22.22 |
| 30S330 G/S PCN | 14.88 | 4.09 | 14.66 | 4.03 |
| Penn Color 32S187D | 1.94 | 0.53 | 1.91 | 0.53 |
| SDA 4927 | 1.50 | 0.16 | 1.48 | 0.16 |
| Zonyl ® FSA | 0.99 | 0.11 | 0.98 | 0.11 |
| PEG 6800 | 4.00 | 0.44 | 3.94 | 0.43 |
| Magnesium Acetate | 0.00 | 0.00 | 1.48 | 0.16 |
| Total | 100.00 | 100.00 | 100.00 | 100.00 |

The films were imaged using the Creo 3244 Spectrum Trendsetter, (manufactured by Creo, Vancouver, BC) and at power settings of 14, 15, 16, 17, and 18 watts; 11 evenly spaced drumspeeds per power setting. The imaging equipment produced a laser-generated matrix of cyan color images on a receiver element for both C3 and S3.

Density readings were taken as in Example 1. Table 3b shows the standard deviation of N solid images that were produced at a given laser power using N evenly spaced energies.

TABLE 3b

| | | | C3 | | S3 | |
|---|---|---|---|---|---|---|
| | | | Average | | Average | |
| Power | Energy Range | | Optical | C3 | Optical | S3 |
| (Watts) | (mJ/sq cm) | N* | Density | Std Dev | Density | Std Dev |
| 14 | 343 to 607 | 11 | 1.48 | 0.067 | 1.32 | 0.023 |
| 15 | 367 to 650 | 11 | 1.50 | 0.058 | 1.35 | 0.013 |
| 16 | 392 to 693 | 11 | 1.55 | 0.056 | 1.37 | 0.012 |
| 17 | 416 to 734 | 11 | 1.56 | 0.037 | 1.36 | 0.026 |
| 18 | 441 to 780 | 11 | 1.55 | 0.052 | 1.29 | 0.040 |

*N is a positive integer defining the number of evenly spaced exposure energies in the given energy range at the given power setting.

In this example, the coating weight of the S3 coating was slightly lower than the C3 control coating, resulting in peak densities of 1.37 and 1.56, respectively.

Nevertheless, the improved imaging latitude of S3, the composition containing added magnesium acetate, can be shown by assessing the standard deviation of the density for each C3 and S3 sample, over a range of power and exposure energy. The standard deviation data of Table 3b show that at each power setting, S3 had a lower standard deviation than C3, and, the difference of the standard deviation across all power settings (14-18 watts) for S3 was 0.28 versus that for C3, which was 0.30. Therefore, S3 had improved imaging latitude when compared to the C3 sample.

### Example 4

Example 4 illustrates the effect of added organic salts on improvements in imaging latitude and imaging at low humidity, with a Fourth Control (C4) being designated as the control.

Sample donor elements (S4, S5 and S6) and the Control (C4) were prepared from a dispersion of the ingredients listed below in Tables 4a1 and 4a2, wherein the amount for each ingredient is provided as parts by weight.

TABLE 4a1

| | C4 | C4 Neat |
|---|---|---|
| Ingredients | % Solids | Ingr. |
| Distilled Water | | 64.12 |
| Binder 1 | 76.65 | 28.66 |
| Penn Color 32S330 | 14.87 | 5.21 |
| Cyan Dispersion | | |
| Penn Color 32S187 | 1.94 | 0.68 |
| Blue Dispersion | | |
| Surfynol ® DF 110D | | |
| Sodium L-Tartrate | | |
| Sodium Acetate | | |
| Crystal Lyn ® 551110 | 1.54 | 0.22 |
| SDA 4927 | | |
| PEG 6800 | 4.01 | 0.56 |
| Zonyl ® FSA | 0.99 | 0.55 |
| Total | 100.00 | 100.00 |

TABLE 4a2

| | | S4 | | S5 | | S6 |
|---|---|---|---|---|---|---|
| | S4 % | Neat | S5 % | Neat | S6 % | Neat |
| Ingredients | Solids | Ingr. | Solids | Ingr. | Solids | Ingr. |
| Distilled | | 65.80 | | 65.80 | | 65.59 |
| Water | | | | | | |
| Binder 1 | 69.96 | 26.16 | 69.96 | 26.16 | 71.74 | 26.80 |
| Penn Color | 14.47 | 5.06 | 14.47 | 5.06 | 14.98 | 5.24 |
| 32S330 Cyan | | | | | | |
| Dispersion | | | | | | |
| Penn Color | 1.89 | 0.66 | 1.89 | 0.66 | 1.95 | 0.68 |
| 32S187 Blue | | | | | | |
| Dispersion | | | | | | |
| Surfynol ® DF | | | | | 0.50 | 0.07 |
| 110D | | | | | | |
| Sodium L- | 7.21 | 1.01 | | | — | — |
| Tartrate | | | | | | |
| Sodium | | | 7.21 | 1.01 | 5.04 | 0.70 |
| Acetate | | | | | | |
| Crystal Lyn ® | 1.51 | 0.21 | 1.51 | 0.21 | — | — |
| 551110 | | | | | | |
| SDA 4927 | | | | | 1.51 | 0.21 |
| PEG 6800 | 4.00 | 0.56 | 4.00 | 0.56 | 4.03 | 0.56 |
| Zonyl ® FSA | 0.96 | 0.54 | 0.96 | 0.54 | 0.25 | 0.14 |
| Total | 100.00 | 100.00 | 100.00 | 100.00 | 100.00 | 100.00 |

Each donor element comprises a 4 mil polyester backing (Melinex® 574, DuPont Teijin Films) sputtered with chromium at a transmittance of 60%. The image transfer coatings were hand coated on the chromium layer using a wire wound rod to a dried coating weight of approximately 12 mg/sq dm.

The films were imaged using the Creo 3244 Spectrum Trendsetter (manufactured by Creo, Vancouver, BC) and imaged at power settings of 14, 15, 16, and 17 wafts; 10 evenly spaced drumspeeds per power setting; and a focus setting of 60 SD units. The imaging equipment produced a laser-generated matrix of cyan color images on a receiver element for both C4 as well as S4, S5 and S6.

The color image formed was then transferred to an image rigidification element comprising Vitel® 2700B polyester on a silicone release Mylar® substrate. The receiver support was peeled off and the image was contacted with an LOE paper substrate followed by peeling off the image rigidification element support to form an image on the LOE paper substrate sandwiched between the polycaprolactone layer and the Vitel® 2700B polyester containing layer.

After imaging, each imaged film on LOE paper was analyzed using an X-Rite® 938 Spectrodensitometer. Cyan density readings were taken of images produced at a set laser power and over an evenly spaced range of energies at that power. The evenly spaced energy ranges were produced by incrementally adjusting the drum speed of the Trendsetter. Table 4b shows the average density of N solid images that were produced at a given laser power using N evenly spaced energies.

Data in Table 4b show that the addition of sodium L-tartrate improved the imaging latitude of S4 versus C4 at both 22% and 45% relative humidity. It is illustrated by measuring the difference of the optical densities across the range of power settings (13-18 watts). S4 had a difference of 0.31 at 22% RH and 0.07 at 45% RH, whereas C4 had a difference of 0.81 at 22% RH and 0.49 at 45% RH, therefore the optical density of C4 varies to a greater extent than that for S4. Thus S4 shows improved imaging latitude when compared to C4.

TABLE 4b

| | | | C4 | C4 | S4 | S4 |
|---|---|---|---|---|---|---|
| | Energy | | Density | Density | Density | Density |
| Power | Range | | @ 22% | @ 45% | @ 22% | @ 45% |
| (Watts) | (mJ/sq cm) | N | RH | RH | RH | RH |
| 13.0 | 407-916 | 11 | 0.44 | 0.98 | 1.09 | 1.36 |
| 13.5 | 423-951 | 11 | 0.49 | 1.08 | 1.19 | 1.40 |
| 14.0 | 438-986 | 11 | 0.57 | 1.19 | 1.29 | 1.43 |
| 14.5 | 454-1021 | 11 | 0.64 | 1.31 | 1.35 | 1.43 |
| 15.0 | 470-1056 | 11 | 0.74 | 1.37 | 1.39 | 1.43 |
| 15.5 | 485-1092 | 11 | 0.84 | 1.42 | 1.40 | 1.42 |
| 16.0 | 501-1127 | 11 | 0.86 | 1.44 | 1.42 | 1.42 |
| 16.5 | 516-1162 | 11 | 0.96 | 1.45 | 1.42 | 1.42 |
| 17.0 | 532-1197 | 11 | 1.07 | 1.46 | 1.41 | 1.41 |
| 17.5 | 548-1232 | 11 | 1.16 | 1.47 | 1.41 | 1.40 |
| 18.0 | 563-1268 | 11 | 1.25 | 1.46 | 1.40 | 1.39 |

Data in Tables 4c and 4d below illustrate the beneficial effect of sodium acetate, wherein there is better overall imaging latitude, particularly at low humidity. The overall improvements are apparent by first measuring the difference of the optical densities shown in Table 4c across the range of power settings (13-18 watts). S5 had a difference of 0.26 at 22% RH and 0.32 at 45% RH, whereas C4 had a difference of 0.81 at 22% RH and 0.49 at 45% RH, therefore the optical density of C4 varies to a greater extent than that for S5. Thus S5 showed improved imaging latitude. The same measurements made utilizing the data of Table 4d further showed the improvement, particularly at low humidity, wherein the difference for S6 at 22% RH was 0.09, at 37% RH was 0.04, at 52% RH was 0.04 and at 62% RH was 0.04, whereas the differences for C4 and the same relative humidities was 0.39, 0.27, 0.04 and 0.02 respectively. Therefore, with regard to the lower humidities, the present invention showed improved imaging latitude.

TABLE 4c

| | | | C4 | C4 | S5 | S5 |
|---|---|---|---|---|---|---|
| | Energy | | Density | Density | Density | Density |
| Power | Range | | @ 22% | @ 45% | @ 22% | @ 45% |
| (Watts) | (mJ/sq cm) | N | RH | RH | RH | RH |
| 13.0 | 407-916 | 11 | 0.44 | 0.98 | 1.18 | 1.10 |
| 13.5 | 423-951 | 11 | 0.49 | 1.08 | 1.24 | 1.19 |
| 14.0 | 438-986 | 11 | 0.57 | 1.19 | 1.32 | 1.30 |
| 14.5 | 454-1021 | 11 | 0.64 | 1.31 | 1.38 | 1.37 |
| 15.0 | 470-1056 | 11 | 0.74 | 1.37 | 1.41 | 1.40 |
| 15.5 | 485-1092 | 11 | 0.84 | 1.42 | 1.42 | 1.42 |
| 16.0 | 501-1127 | 11 | 0.86 | 1.44 | 1.44 | 1.43 |
| 16.5 | 516-1162 | 11 | 0.96 | 1.45 | 1.44 | 1.43 |
| 17.0 | 532-1197 | 11 | 1.07 | 1.46 | 1.44 | 1.43 |
| 17.5 | 548-1232 | 11 | 1.16 | 1.47 | 1.43 | 1.43 |
| 18.0 | 563-1268 | 11 | 1.25 | 1.46 | 1.42 | 1.42 |

TABLE 4d

| | | Energy | Density | Density | Density | Density |
|---|---|---|---|---|---|---|
| | Power | Range | @ 22% | @ 37% | @ 52% | @ 62% |
| Film | (Watts) | (mJ/sq cm) | RH | RH | RH | RH |
| C4 | 15 | 367-768 | 0.99 | 1.17 | 1.41 | 1.46 |
| C4 | 16 | 392-819 | 1.12 | 1.34 | 1.44 | 1.46 |
| C4 | 17 | 416-871 | 1.32 | 1.44 | 1.45 | 1.47 |
| C4 | 18 | 441-922 | 1.38 | 1.44 | 1.43 | 1.45 |
| S6 | 15 | 367-768 | 1.34 | 1.41 | 1.43 | 1.44 |
| S6 | 16 | 392-819 | 1.40 | 1.42 | 1.42 | 1.43 |
| S6 | 17 | 416-871 | 1.44 | 1.45 | 1.44 | 1.44 |
| S6 | 18 | 441-922 | 1.43 | 1.43 | 1.40 | 1.41 |

The film containing sodium acetate also exhibited a beneficial effect on color stability relative to the control, which is illustrated by the data shown in Table 4e. Note that after 28 days, the DE change for S6 is <1.

TABLE 4e

| Film | Age | L* | a* | b* | DL* | Da* | Db* | DE* |
|---|---|---|---|---|---|---|---|---|
| C4 | 0 | 52.45 | −37.69 | −45.42 | 0.00 | 0.00 | 0.00 | 0.00 |
| C4 | 1 d | 53.27 | −36.08 | −48.85 | 0.82 | 1.61 | −3.43 | 3.88 |
| C4 | 4 d | 53.52 | −34.58 | −51.28 | 1.07 | 3.11 | −5.86 | 6.72 |
| C4 | 7 d | 53.57 | −33.60 | −52.86 | 1.12 | 4.09 | −7.44 | 8.56 |
| C4 | 14 d | 53.97 | −33.10 | −53.50 | 1.52 | 4.59 | −8.08 | 9.42 |
| C4 | 21 d | 54.14 | −32.79 | −53.64 | 1.69 | 4.90 | −8.22 | 9.72 |
| C4 | 28 d | 54.19 | −32.75 | −54.02 | 1.74 | 4.94 | −8.60 | 10.07 |
| S6 | 0 | 55.47 | −34.30 | −53.54 | 0.00 | 0.00 | 0.00 | 0.00 |
| S6 | 1 d | 55.41 | −34.37 | −53.38 | −0.06 | −0.07 | 0.16 | 0.18 |
| S6 | 5 d | 55.35 | −34.30 | −53.46 | −0.12 | 0.00 | 0.08 | 0.14 |
| S6 | 7 d | 55.50 | −34.25 | −53.38 | 0.03 | 0.05 | 0.16 | 0.17 |
| S6 | 14 d | 55.56 | −34.13 | −53.05 | 0.09 | 0.17 | 0.49 | 0.53 |
| S6 | 21 d | 55.57 | −33.94 | −52.67 | 0.10 | 0.36 | 0.87 | 0.95 |
| S6 | 28 d | 55.70 | −34.00 | −52.80 | 0.23 | 0.30 | 0.74 | 0.83 |

### Example 5

Example 5 demonstrates the effect of polyacid salts on imaging at low humidity, for example, 22% relative humidity.

Sample donor elements (S7, S8, S9 and S10) and a Sixth Control (C6) were prepared from a dispersion of the ingredients listed below in Table 5a, wherein the amount for each ingredient is provided as parts by weight. There is no control sample designated as C5. The polyacid salts were obtained from Rohm and Haas.

TABLE 5a

| | | S7 | | S8 | | S9 | | S10 |
|---|---|---|---|---|---|---|---|---|
| | S7 % | Neat | S8 % | Neat | S9 % | Neat | S10 % | Neat |
| Ingredients | Solids | Ingr. | Solids | Ingr. | Solids | Ingr. | Solids | Ingr. |
| Distilled | | 62.31 | | 61.71 | | 61.50 | | 62.11 |
| Water | | | | | | | | |
| Dispersant 1 | 72.78% | 29.16 | 73.93% | 29.62 | 74.33% | 29.78 | 73.16% | 29.31 |
| Penn Color | 14.12% | 5.30 | 14.35% | 5.38 | 14.42% | 5.41 | 14.20% | 5.32 |
| 32S330 | | | | | | | | |
| Cyan | | | | | | | | |
| Dispersion | | | | | | | | |
| Penn Color | 1.84% | 0.69 | 1.87% | 0.70 | 1.88% | 0.71 | 1.85% | 0.70 |
| 32S187 | | | | | | | | |
| Blue | | | | | | | | |
| Dispersion | | | | | | | | |
| Acumer | 4.69% | 1.56 | | | | | | |
| 1110 | | | | | | | | |
| Acumer | | | 3.18% | 1.59 | | | | |
| 1850 | | | | | | | | |
| Tamol ® | | | | | 2.66% | 1.60 | | |
| 731A | | | | | | | | |
| Tamol ® | | | | | | | 4.19% | 1.57 |
| 960 | | | | | | | | |
| Crystal | 1.46% | 0.22 | 1.48% | 0.22 | 1.49% | 0.22 | 1.47% | 0.22 |
| Lyn ® | | | | | | | | |
| 551110 | | | | | | | | |
| PEG 6800 | 4.17% | 0.63 | 4.24% | 0.64 | 4.26% | 0.64 | 4.19% | 0.63 |
| Zonyl ® | 0.94% | 0.14 | 0.95% | 0.14 | 0.96% | 0.14 | 0.94% | 0.14 |
| FSA | | | | | | | | |
| Total | 100.00% | 100.00 | 100.00% | 100.00 | 100.00% | 100.00 | 100.00% | 100.00 |

Tables 5b, 5c, 5d and 5e illustrate the improved imaging latitude for S7, S8, S9, S10 at low humidity, when compared to C6. S7, S8, S9, and S10 showed increased density at each power setting and corresponding energy range at 22% relative humidity. Thus, the samples of the present invention provided better imaging latitude than C6.

TABLE 5b

| | | | C6 | S7 |
|---|---|---|---|---|
| Power | Energy Range | | Density @ | Density @ |
| (Watts) | (mJ/sq cm) | N | 22% RH | 22% RH |
| 13.0 | 407-916 | 11 | 0.43 | 1.23 |
| 13.5 | 423-951 | 11 | 0.50 | 1.27 |
| 14.0 | 438-986 | 11 | 0.57 | 1.34 |
| 14.5 | 454-1021 | 11 | 0.65 | 1.40 |
| 15.0 | 470-1056 | 11 | 0.75 | 1.45 |
| 15.5 | 485-1092 | 11 | 0.83 | 1.49 |
| 16.0 | 501-1127 | 11 | 0.90 | 1.52 |
| 16.5 | 516-1162 | 11 | 0.99 | 1.55 |
| 17.0 | 532-1197 | 11 | 1.07 | 1.56 |
| 17.5 | 548-1232 | 11 | 1.18 | 1.56 |
| 18.0 | 563-1268 | 11 | 1.26 | 1.56 |

TABLE 5c

| | | | C6 | S8 |
|---|---|---|---|---|
| Power | Energy Range | | Density @ | Density @ |
| (Watts) | (mJ/sq cm) | N | 22% RH | 22% RH |
| 13.0 | 407-916 | 11 | 0.43 | 1.31 |
| 13.5 | 423-951 | 11 | 0.50 | 1.50 |
| 14.0 | 438-986 | 11 | 0.57 | 1.59 |
| 14.5 | 454-1021 | 11 | 0.65 | 1.61 |
| 15.0 | 470-1056 | 11 | 0.75 | 1.61 |
| 15.5 | 485-1092 | 11 | 0.83 | 1.62 |
| 16.0 | 501-1127 | 11 | 0.90 | 1.59 |
| 16.5 | 516-1162 | 11 | 0.99 | 1.54 |
| 17.0 | 532-1197 | 11 | 1.07 | 1.48 |
| 17.5 | 548-1232 | 11 | 1.18 | 1.41 |
| 18.0 | 563-1268 | 11 | 1.26 | 1.34 |

TABLE 5d

| | | | C6 | S9 |
|---|---|---|---|---|
| Power | Energy Range | | Density @ | Density @ |
| (Watts) | (mJ/sq cm) | N | 22% RH | 22% RH |
| 13.0 | 407-916 | 11 | 0.43 | 0.57 |
| 13.5 | 423-951 | 11 | 0.50 | 0.81 |
| 14.0 | 438-986 | 11 | 0.57 | 1.08 |
| 14.5 | 454-1021 | 11 | 0.65 | 1.33 |
| 15.0 | 470-1056 | 11 | 0.75 | 1.52 |
| 15.5 | 485-1092 | 11 | 0.83 | 1.65 |
| 16.0 | 501-1127 | 11 | 0.90 | 1.65 |
| 16.5 | 516-1162 | 11 | 0.99 | 1.65 |
| 17.0 | 532-1197 | 11 | 1.07 | 1.66 |
| 17.5 | 548-1232 | 11 | 1.18 | 1.64 |
| 18.0 | 563-1268 | 11 | 1.26 | 1.59 |

TABLE 5e

| | | | C6 | S10 |
|---|---|---|---|---|
| Power | Energy Range | | Density @ | Density @ |
| (Watts) | (mJ/sq cm) | N | 22% RH | 22% RH |
| 13.0 | 407-916 | 11 | 0.43 | 1.21 |
| 13.5 | 423-951 | 11 | 0.50 | 1.31 |
| 14.0 | 438-986 | 11 | 0.57 | 1.34 |
| 14.5 | 454-1021 | 11 | 0.65 | 1.4 |
| 15.0 | 470-1056 | 11 | 0.75 | 1.44 |
| 15.5 | 485-1092 | 11 | 0.83 | 1.48 |
| 16.0 | 501-1127 | 11 | 0.90 | 1.49 |
| 16.5 | 516-1162 | 11 | 0.99 | 1.48 |
| 17.0 | 532-1197 | 11 | 1.07 | 1.46 |
| 17.5 | 548-1232 | 11 | 1.18 | 1.47 |
| 18.0 | 563-1268 | 11 | 1.26 | 1.45 |

### Example 6

Example 6 shows the improved imaging latitude by the incorporation of magnesium sulfate into a magenta donor composition.

A sample donor element (S11) and a Seventh Control (C7) were prepared from a dispersion of the ingredients listed below in Table 6a, wherein the amount for each ingredient is provided as parts by weight. Each donor element was prepared as in Example 1, except that the targeted coating weight was approximately 13 mg/sq dm.

TABLE 6a

| | C7 | C7 Neat | S11 | S11 Neat |
|---|---|---|---|---|
| Ingredients | % Solids | Ingredients | % Solids | Ingredients |
| Distilled Water | 0.00 | 70.78 | 0.00 | 70.57 |
| Hycar ® 26256 | 71.40 | 20.31 | 72.90 | 20.74 |
| Penn Color | 22.82 | 8.03 | 22.82 | 8.03 |
| 32R164D - magenta | | | | |
| (red acroverse disp) | | | | |
| Penn Color | 0.30 | 0.10 | 0.30 | 0.10 |
| 32S168 - violet | | | | |
| (blue shade) | | | | |
| Crysta Lyn 551110 | 1.99 | 0.28 | 1.99 | 0.28 |
| Magnesium Sulfate, | 1.50 | 0.21 | 0.00 | 0.00 |
| anhydrous | | | | |
| Zonyl FSO-100 | 1.99 | 0.28 | 1.99 | 0.28 |
| Total | 100.00 | 100.00 | 100.00 | 100.00 |

The films were imaged using the Creo 3244 Spectrum Trendsetter (manufactured by Creo, Vancouver, BC) and at power settings of 14, 15, 16, 17, and 18 watts and at a drumspeed of 120 rpm. The imaging equipment produced 5 laser generated magenta color images on a receiver element corresponding to the 5 power settings for both the Control (C7) and S1. Density readings were taken and tabulated. Table 6b shows the average density and the standard deviation of the solid images that were produced using 5 evenly spaced power settings.

TABLE 6b

| | Power Range | | Average | | |
|---|---|---|---|---|---|
| Film | (Watts) | N* | Density | Std Dev | % Std Dev |
| C7 | 14 to 18 | 5 | 1.498 | 0.045 | 3.04 |
| S11 | 14 to 18 | 5 | 1.668 | 0.044 | 2.63 |

*N is a positive integer defining N evenly spaced exposures in the given power range.

Table 6b data shows that S11, the composition containing increased magnesium sulfate, has improved imaging latitude versus the control film over the working range of 14 to 18 watts. This is illustrated by the increased image density and decreased standard deviation of S11 relative to C7.

### Example 7

Example 7 shows the improved imaging latitude by the addition of an organic base, N,N-dimethylethanolamine (DMEA), into a cyan donor composition containing a high pH (=8.8) carboxylated acrylic colloidal dispersion, Carboset® GA2123.

A sample donor element (S12) and an Eighth Control (C8) were prepared from a dispersion of the ingredients listed below in Table 7a, wherein the amount for each ingredient is provided as parts by weight. Each donor element was prepared as in Example 1, except they were coated to a coating weight of approximately 9 mg/sq dm.

TABLE 7A

| | C8 | C8 Neat | S12 | S12 Neat |
|---|---|---|---|---|
| Ingredients | % Solids | Ingredients | % Solids | Ingredients |
| Distilled Water | 0.00 | 66.18 | 0.00 | 66.54 |
| Carboset ® | 67.33 | 26.93 | 66.34 | 26.54 |
| GA2123 | | | | |
| 30S330 G/S | 29.27 | 6.59 | 28.83 | 6.49 |
| PCN | | | | |
| Crysta Lyn | 2.01 | 0.18 | 1.98 | 0.18 |
| 551110 | | | | |
| DMEA | 0.00 | 0.00 | 1.48 | 0.13 |
| Zonyl FSO | 1.39 | 0.13 | 1.37 | 0.12 |
| Total | 100.00 | 100.00 | 100.00 | 100.00 |

The films were imaged using the Creo 3244 Spectrum Trendsetter (manufactured by Creo, Vancouver, BC) and at power settings of 14, 15, 16, 17, and 18 watts; 11 evenly spaced drumspeeds per power setting. The imaging equipment produced a laser-generated matrix of cyan color images on a receiver element for both C8 and S12.

Density readings were taken and tabulated as in Example 1. Table 7b shows the average density and standard deviation of N solid images that were produced at a given laser power using N evenly spaced energies.

TABLE 7b

| | Power | Energy Range | | Average | | |
|---|---|---|---|---|---|---|
| Film | (Watts) | (mJ/sq cm) | N | Density | Std Dev | % Std Dev |
| C8 | 14 | 343 to 607 | 11 | 1.24 | 0.29 | 23.63 |
| C8 | 15 | 367 to 650 | 11 | 1.33 | 0.17 | 12.54 |
| C8 | 16 | 392 to 693 | 11 | 1.38 | 0.09 | 6.23 |
| C8 | 17 | 416 to 734 | 11 | 1.41 | 0.04 | 3.05 |
| C8 | 18 | 441 to 780 | 11 | 1.36 | 0.03 | 2.34 |
| S12 | 14 | 343 to 607 | 11 | 1.42 | 0.18 | 13.02 |
| S12 | 15 | 367 to 650 | 11 | 1.45 | 0.06 | 4.46 |
| S12 | 16 | 392 to 693 | 11 | 1.46 | 0.04 | 2.86 |
| S12 | 17 | 416 to 734 | 11 | 1.45 | 0.03 | 2.34 |
| S12 | 18 | 441 to 780 | 11 | 1.40 | 0.04 | 2.67 |

*N is a positive integer defining N evenly spaced exposure energies in the given energy range at the given power setting.

Table 7b data shows that S12, the composition containing increased N,N-dimethylethanolamine, had improved imaging latitude compared to CB over the working power range of 14 to 18 watts, which is evidenced by an increased image density relative to the control film as well as the overall decreased standard deviation relative to the control film.

Freshly made proofs of CB and S12 were aged under ambient room light and both samples were exceptionally color stable. The 28 day aged C8 experienced a delta E of 0.66 units. The 28 day aged S12 experienced a delta E of 0.65 units.

### Example 8

Example 8 shows the improved imaging latitude resulting from the incorporation of the salt, magnesium acetate, into a cyan donor composition.

A sample donor element (S13) of the present invention and a Ninth Control (C9) were prepared from a dispersion of the ingredients listed below in Table 8a, wherein the amount of each ingredient is provided as parts by weight.

Each donor element was prepared as in Example 1 wherein the S13 composition was coated with the same wire wound rod as C9.

TABLE 8A

| | C9 % | C9 Neat | S13 | S13 Neat |
|---|---|---|---|---|
| Ingredients | Solids | Ingredients | % Solids | Ingredients |
| Distilled Water | 0.00 | 71.90 | 0.00 | 72.26 |
| Binder 1 | 77.26 | 22.72 | 75.26 | 22.14 |
| 30S330 G/S PCN | 14.99 | 4.12 | 14.99 | 4.12 |
| Penn Color 32S187D | 1.95 | 0.54 | 1.95 | 0.54 |
| SDA 4927 | 1.51 | 0.17 | 1.51 | 0.17 |
| Zonyl ® FSA (25% s) | 0.25 | 0.11 | 0.25 | 0.11 |
| PEG 6800 | 4.03 | 0.44 | 4.03 | 0.44 |
| Magnesium Acetate | 0.00 | 0.00 | 2.00 | 0.22 |
| Total | 100.00 | 100.00 | 100.00 | 100.00 |

The films were imaged using the Creo 3244 Spectrum Trendsetter, (manufactured by Creo, Vancouver, BC) and at 7 power settings of 12, 13, 14, 15, 16, 17, and 18 watts and constant drum speed. The imaging equipment produced a laser-generated series of cyan color images on a receiver element for both C9 and S13.

Density readings were taken as in Example 1. Table 8b shows the average density and the standard deviation of N solid images that were produced at a given drum speed using 7 evenly spaced energies.

TABLE 8B

| | | | C9 | |
|---|---|---|---|---|
| | Energy | | Average | S13 |
| Power (Watts) | (mJ/sq cm) | N* | Density | Average Density |
| 12 | 356 | 7 | 0.00 | 1.33 |
| 13 | 385 | 7 | 0.24 | 1.44 |
| 14 | 415 | 7 | 1.50 | 1.47 |
| 15 | 445 | 7 | 1.50 | 1.48 |
| 16 | 474 | 7 | 1.57 | 1.48 |
| 17 | 504 | 7 | 1.57 | 1.51 |
| 18 | 534 | 7 | 1.56 | 1.53 |

*N is a positive integer defining N evenly spaced exposure energies in the energy range of 356 to 534 mJ/sq cm.

The average density over power series for C9 was 1.13 and the standard deviation over power series for C9 was 0.70. The average density over power series for S13 was 1.46 and the standard deviation over power series for S13 was 0.06

The improved imaging latitude of S13, the composition containing added magnesium acetate, can be shown by assessing from Table 8b the rise in density with exposure power. The S13 density is notably higher at lower power settings than the C9 density.

The improved imaging latitude of S13, the composition containing added magnesium acetate, can also be shown by assessing from Table 8b the difference in the average density for S13 across the range of power settings 12-18 watts, wherein the difference for S13 was 0.20, whereas the difference for C9 was 1.56, therefore, S13 had improved imaging latitude when compared to the C9 sample.

What is claimed is:

1. An image transfer element for thermally induced image transfer comprising:
a donor element support;
a colorant layer disposed upon said donor element support, wherein the colorant layer comprises a polymeric binder, a colorant, a surfactant in an amount ranging from about 0.1 to about 6.0% solid based on the total solids content and a metal salt having the structure:
Mₐ⁺ⁿX_{b}^{-q}
wherein M⁺ⁿ is an organic cation, an inorganic cation, or a combination thereof; n=1, 2 or 3; X is an anion or an aliphatic group containing from 1 to 5 carbon atoms containing an anion; q=1, 2, or 3; and a and b are integers wherein (a)(n)=(b)(q).

2. The image transfer element according to claim 1, wherein at least one heating layer is disposed between the donor element support and the colorant layer.

3. The image transfer element according to claim 2, wherein the at least one heating layer comprises a compound selected from the group consisting of organic and inorganic materials, wherein the materials may inherently absorb laser radiation.

4. The image transfer element according to claim 3, wherein the inorganic materials of the heating layer are selected from the group consisting of transition metal elements of Groups IIIA, IVA, VA, VIA, VIIIA, IIB, IIIB, and VB of the Period Table of the Elements, metallic elements of Groups IIIA, IVA, VA, VIA, VIIIA, IIIB, IIIB, and VB of the Period Table of the Elements, their alloys with each other, and their alloys with the elements of Groups IA and IIA.

5. The image transfer element according to claim 3, wherein the organic and inorganic materials of the heating layer further include a laser-radiation absorbing compound selected from the group consisting of chromium, aluminum, carbon black, NIR cyanine dye compounds and combinations thereof.

6. The image transfer element according to claim 1, wherein the polymeric binder is selected from the group consisting of a homopolymer or copolymer of acrylic acid, a homopolymer or copolymer of esters of acrylic acid, a homopolymer or copolymer of methacrylic acid, a homopolymer or copolymer of esters of methacrylic acid, a homopolymer or copolymer of alkyl methacrylic acid, a homopolymer or copolymer of esters of alkyl methacrylic acid acrylate esters, copolymers of styrene and olefin monomers, copolymers of styrene and acrylonitrile; fluoropolymers, copolymers of (meth)acrylate esters with ethylene and carbon monoxide, (meth)acrylate block copolymers, and (meth)acrylate copolymers containing other comonomer types, polycarbonates, (meth)acrylate homopolymers and copolymers, polysulfones, polyurethanes, polyesters, and combinations thereof.

7. The image transfer element according to claim 3, wherein the polymeric binder is selected from the group consisting of starch derivatives, carboxymethylcellulose, polyvinyl alcohols based on acrylic acid, acrylic acid esters, acrylonitrile, vinyl acetate, butadiene, styrene and combinations thereof, and aqueous dispersions based on acrylic acid, acrylic acid esters, acrylonitrile, vinyl acetate, butadiene, styrene and combinations thereof.

8. The image transfer element according to claim 1 wherein M⁺ⁿ is selected from the group consisting of Na⁺¹, Li⁺¹, K⁺¹, Mg⁺², Ca⁺², Sr⁺², Ba⁺², Fe⁺², Fe⁺³, Cu⁺², Zn⁺², Al⁺³, NH₄⁺, N(R¹)₄⁺ and S(R¹)₃⁺, wherein R¹ is an aliphatic group containing 1 to 6 carbon atoms.

9. The image transfer element according to claim 1 in which M⁺ⁿ is selected from the group consisting of N(C₂H₅)₄⁺, N(C₃H₇)₄⁺, N(C₄H₉)₄⁺, S(CH₃)₃⁺, S(C₂H₅)₃⁺, S(C₃H₇)₃⁺ and S(C₄H₉)₃⁺.

10. The image transfer element according to claim 1 wherein X^{-q} is selected from the group consisting of SO₄⁻², SO₃⁻², HSO₃⁻, S₂O₃⁻², S₂O₅⁻², PO₄⁻³, HPO₄⁻², H₂PO₄⁻, F⁻, Cl⁻, Br⁻, I⁻, CO₃⁻², HCO₃⁻, acetate ion and acetylacetate ion.

11. The image transfer element according to claim 1 wherein the metal salt is magnesium sulfate, magnesium acetate, magnesium chloride, aluminum sulfate, calcium chloride, or AlK(SO₄)₂ and Al(NH₄)(SO₄)₂.

12. The image transfer element according to claim 1, wherein the metal salt is selected from the group consisting of anhydrates or hydrates of metal salts.

13. The image transfer element of claim 1 in which the metal salt is a carboxylate salt.

14. The image transfer layer according to claim 2, further comprising at least one ejection layer comprising a compound selected from the group consisting of polycarbonates having low decomposition temperatures (Td), substituted styrene polymers having low decomposition temperatures, polyacrylate and polymethacrylate esters, cellulosic materials having low decomposition temperatures (Td), polyvinyl chloride, poly(chlorovinyl chloride) polyacetals, polyvinylidene chloride, polyurethanes with low Td, polyesters, polyorthoesters, acrylonitrile, substituted acrylonitrile polymers, maleic acid resins, copolymers of the above compounds and mixtures thereof.

15. The image transfer element according to claim 1, wherein the colorant is selected from the group consisting of a substantially transparent organic pigment, a substantially transparent inorganic, an opaque organic pigment, an opaque inorganic pigment, a dye, a color-forming dye and combinations thereof.

16. The image transfer element according to claim 1, wherein the colorant layer further comprises a thermal amplification additive.

17. The image transfer element according to claim 2, wherein the at least one heating layer further comprises a thermal amplification additive.

18. The image transfer element according to claim 14, wherein the at least one ejection layer further comprises a thermal amplification additive.

19. An image transfer element for thermally induced image transfer comprising:
a donor element support selected from the group consisting of a co-extruded polyethylene terephthalate film, a polyolefin film and a paper;
a colorant layer disposed upon said donor element support, wherein the colorant layer comprises a polymeric binder selected from the group consisting of starch derivatives, carboxymethylcellulose, polyvinyl alcohols based on acrylic acid, acrylic acid esters, acrylonitrile, vinyl acetate, butadiene, styrene and combinations thereof, and aqueous dispersions based on acrylic acid, acrylic acid esters, acrylonitrile, vinyl acetate, butadiene, styrene and combinations thereof; a colorant, a surfactant in an amount ranging from about 0.1 to about 6.0% solid based on the total solids content and a metal salt having the structure:
Mₐ⁺ⁿX_{b}^{-q}
M⁺ⁿ is selected from the group consisting of N(C₂H₅)₄⁺, N(C₃H₇)₄⁺, N(C₄H₉)₄⁺, S(CH₃)₃⁺, S(C₂H₅)₃⁺, S(C₃H₇)₃⁺ and or S(C₄H₉)₃⁺; X-q is selected from the group consisting of SO₄⁻², SO₃⁻², HSO₃⁻, S₂O₃⁻², S₂O₅⁻², OAc⁻, PO₄⁻³, HPO₄⁻², H₂PO₄⁻, halogen, CO₃⁻², HCO₃⁻, and acetylacetate; and a and b are integers where (a)(n)=(b)(q); and
at least one heating layer is disposed between the donor element support and the colorant layer.

20. A laserable assemblage comprising the image transfer element according to claim 1 and a receiver element.

21. A process for producing a thermal image, wherein the process comprises the steps of:
(a) imagewise exposing the laser assemblage according to claim 19 to a laser;
(b) separating the donor element according to claim 1 from a receiver element; and optionally
(c1) transferring the image receiving layer to a permanent substrate; or
(c2) transferring the image receiving layer to an intermediate element and subsequently to a permanent substrate; or
(c3) removing the receiver support resulting in an assemblage or sandwich comprising the permanent substrate, the thermoplastic layer, the colored transfer image, and the image receiving layer.

22. A process for improving imaging latitude in the production of a thermal image comprising the steps of imagewise exposing to laser radiation an assemblage comprising a receiver element and an image transfer element for thermally induced image transfer comprising:
a donor element support;
a colorant layer disposed upon said donor element support, wherein the colorant layer comprises a polymeric binder, a colorant, a surfactant in an amount ranging from about 0.1 to about 6.0% solid based on the total solids content and a metal salt having the structure:
Mₐ⁺ⁿX_{b}^{-q}
wherein M⁺ⁿ is an organic cation, an inorganic cation, or a combination thereof; n=1, 2 or 3; X is an anion or an aliphatic group containing from 1 to 5 carbon atoms containing an anion; q=1, 2, or 3; and a and b are integers wherein (a)(n)=(b)(q).

23. A method for making a monochrome or color filter element suitable for use in a liquid crystal display device, comprising the steps of:
heating an image transfer element comprising:
a donor element having a support layer and a colorant layer and an image receiver, the colorant layer being sandwiched between the support layer and the image receiver;
the colorant layer comprising a polymeric binder, a colorant, a surfactant in an amount ranging from about 0.1 to about 6.0% solid based on the total solids content and a metal salt having the structure:
Mₐ⁺ⁿX_{b}^{-q}
wherein M⁺ⁿ is an organic cation, an inorganic cation, or a combination thereof; n=1, 2 or 3; X is an anion or an aliphatic group containing from 1 to 5 carbon atoms containing an anion; q=1, 2, or 3; and a and b are integers wherein (a)(n)=(b)(q);
imagewise exposing part of the image transfer element to actinic radiation to provide an exposed assemblage;
separating support layer from the receiver of the exposed assemblage to obtain a color filter element.

24. The method of claim 23 in which the receiver is glass.

25. A method for making a liquid crystal display device comprising a the monochrome or color filter element made by the method of claim 23 associated with an electrically conductive coating, a liquid crystal material and an alignment layer.
